(19) United States
(12) Patent Application Publication
(10) Pub. No.: US 2024/0385088 A1
(43) Pub. Date: Nov. 21, 2024

(54) ACTUATED SAMPLE HANDLING SYSTEM

(71) Applicant: 10x Genomics, Inc., Pleasanton, CA (US)

(72) Inventors: Hanyoup Kim, Foster City, CA (US); Liza S. Man, San Mateo, CA (US); Nabil Mikhaiel, Dublin, CA (US); Pratomo Putra Alimsijah, Palo Alto, CA (US); Hendricus Marindra, Pleasanton, CA (US)

(21) Appl. No.: 18/666,097

(22) Filed: May 16, 2024

Related U.S. Application Data
(60) Provisional application No. 63/502,863, filed on May 17, 2023.

(51) Int. Cl. G01N 1/31; G01N 21/01

(52) U.S. Cl. CPC G01N 1/312; G01N 21/01

(57) ABSTRACT

A system for capturing analytes from a sample is provided. The system includes an upper housing including a linear actuator, a linear motion member coupled to the linear actuator, a tilt member rotatably coupled to the linear motion member, and at least one sample support member coupled to the tilt member. The system includes a lower housing including a base support member. The system also includes an alignment mechanism coupling the upper housing to the lower housing. The upper housing and the lower housing have an open configuration and a closed configuration. The alignment mechanism is configured to move the upper housing and the lower housing between the open configuration and the closed configuration. In the closed configuration, the linear actuator is configured to, upon energizing, translate the at least one sample support member towards the base support member. Related apparatuses and methods of use are also provided.

### CROSS-REFERENCE TO RELATED APPLICATIONS

The present application claims priority under 35 U.S.C. § 119 to U.S. Provisional Application No. 63/502,863 entitled “ACTUATED SAMPLE HANDLING SYSTEM” filed on May 17, 2023, which is hereby expressly incorporated by reference in its entirety.

### BACKGROUND

Cells within a tissue of a subject have differences in cell morphology and/or function due to varied analyte levels (e.g., gene and/or protein expression) within the different cells. The specific position of a cell within a tissue (e.g., the cell's position relative to neighboring cells or the cell's position relative to the tissue microenvironment) can affect, e.g., the cell's morphology, differentiation, fate, viability, proliferation, behavior, signaling and cross-talk with other cells in the tissue.

Spatial heterogeneity has been previously studied using techniques that only provide data for a small handful of analytes in the context of an intact tissue or a portion of a tissue, or provide a lot of analyte data for single cells, but fail to provide information regarding the position of the single cell in a parent biological sample (e.g., tissue sample).

Analytes within the biological sample are generally released through disruption (e.g., permeabilization) of the biological sample. Various embodiments of actuated sample handling systems configured to deliver permeabilization reagents to the biological sample are described herein.

### SUMMARY

The present disclosure features embodiments of actuated sample handling systems configured to cause sample substrates including biological samples to contact array substrates including arrays of bar-coded oligonucleotides for use in spatialomic analyte detection and analysis.

Thus, in one aspect, included herein is a system. In one embodiment, the system can include an upper housing. The upper housing can include a linear actuator, a linear motion member coupled to the linear actuator, a tilt member rotatably coupled to the linear motion member, and at least one sample support member coupled to the tilt member. The system can also include a lower housing including a base support member. The system can further include an alignment mechanism coupling the upper housing to the lower housing. The upper housing and the lower housing can have an open configuration and a closed configuration. The alignment mechanism can be configured to move the upper housing and the lower housing between the open configuration and the closed configuration. In the closed configuration, the linear actuator can be configured to, upon energizing, translate the at least one sample support member towards the base support member.

In another embodiment, the alignment mechanism can include a hinge. In some embodiments, the alignment mechanism can include a multi-arm linkage. In another embodiment, the upper housing can further include a frame having at least one bushing. The linear motion member can include at least one shaft disposed within the at least one bushing. In one embodiment, the system can further include at least one tension spring coupling the linear motion member to the tilt member. In another embodiment, the system can include at least one compression spring coupling the tilt member to the at least one sample support member. In another embodiment, the system can include at least one compression spring coupling the tilt member to the at least one sample support member. In some embodiments, the tilt member can include a first arm and a second arm together defining a rotational axis, and the at least one sample support member can be configured to rotate about the rotational axis the tilt member can be coupled to the linear motion member via at least two pivots.

In some embodiments, the at least two pivots can include a ball-in-slot pivot. In other embodiments, the at least two pivots can include a ball-in-place pivot. In another embodiment, the linear motion member can include a first arm and a second arm together defining a rotational axis. The tilt member can be rotatably coupled to the first arm and the second arm. The tilt member can be configured to rotate about the rotational axis. In another embodiment, each of the at least one sample member is coupled to the tilt member via a ball-in-slot joint and a ball joint. In one embodiment, the upper housing further can include at least one stopper configured to limit an angular range of motion of the at least one sample support member. In some embodiments, the linear motion member can include an upper linear motion member and a lower linear motion member. The upper linear motion member can be coupled to the lower motion portion and the upper linear motion member is coupled to the linear actuator. In another embodiment, the lower linear motion member can include a first aperture, the tilt member can include a second aperture, and each of the at least one sample support members can include a sample window.

In one embodiment, the upper housing further can include a light emitting diode (LED) assembly positioned on the lower linear motion member. The LED assembly can be configured to emit light through the first aperture, second aperture, and the sample window for each of the at least one sample support member. In another embodiment, the LED assembly can include a light guide. The light guide can include a top surface, a bottom surface, and at least one side, a plurality of LEDs positioned around the light guide and configured to direct light through the at least one side, and a light diffuser positioned below the bottom surface of the light guide. In some embodiments, an area of the light guide can substantially equal the area of the first aperture. In one embodiment, the top surface of the light guide can include a reflective layer. In another embodiment, the reflective layer can include a metal. In some embodiments, the reflective layer can include a silvered surface. In one embodiments, the reflective layer can include a coating. In some embodiments, the coating can include nanoparticles disposed within a matrix. In another embodiment, the nanoparticles can include metallic oxide nanoparticles or titanium dioxide nanoparticles. In one embodiment, a mean diameter of the nanoparticles is less than or equal to 600 nm. In some embodiments, the matrix can include an epoxy polymer.

In another embodiment, the lower housing can further include a focus stage. The focus stage can include a stage, a motor configured to translate the stage, and at least one image sensor positioned on the stage and at least one lens positioned on the stage. In some embodiments, the base support member can include at least one base window. Each of the at least one base window is configured to align with the at least one sample window in the closed configurations. In one embodiment, the lower housing can include at least one mirror configured to reflect light from the LED assembly to the at least one image sensor. In another embodiment, the at least one mirror can include a right-angle prism. In other embodiments, the base support member can define a first plane at a first angle relative to a horizontal plane. In some embodiments, the first angle is about 3 degrees. In one embodiment, the at least one support member can define a second plate at a second angle relative to the first plane. In another embodiment, the second angle can be about 4 degrees. In one embodiment, the system can include a spacer configured to maintain a predetermined distance between the at least one sample support member and the base support member after the linear actuator translates the at least one sample support member toward the base support member.

In another embodiment, the system can further include at least one retaining mechanism positioned on the at least one sample support member and configured to retain a sample substrate against the sample support member. In some embodiments, the at least one retaining mechanism can include a clip. In other embodiments, the system can further include at least one second retaining mechanism positioned on base support member and configured to retain an array substrate within the base support member. The at least one second retaining mechanism can include a spring-loaded member.

All publications, patents, and patent applications mentioned in this specification are herein incorporated by reference to the same extent as if each individual publication, patent, patent application, or item of information was specifically and individually indicated to be incorporated by reference. To the extent publications, patents, patent applications, and items of information incorporated by reference contradict the disclosure contained in the specification, the specification is intended to supersede and/or take precedence over any such contradictory material.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

The term “each,” when used in reference to a collection of items, is intended to identify an individual item in the collection but does not necessarily refer to every item in the collection, unless expressly stated otherwise, or unless the context of the usage clearly indicates otherwise.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

### DESCRIPTION OF DRAWINGS

The following drawings illustrate certain embodiments of the features and advantages of this disclosure. These embodiments are not intended to limit the scope of the appended claims in any manner. Like reference symbols in the drawings indicate like elements.

FIG. 1 is a perspective view of an exemplary embodiment of a sample handling system as described herein.

FIG. 2 is a perspective view of a lower housing of the sample handling system of FIG. 1.

FIG. 3 is a perspective view of the lower housing of the sample handling system of FIG. 1 with a housing cover removed.

FIG. 4A is a top view of the lower housing of the sample handling system of FIG. 3 with a shroud and the housing cover removed.

FIG. 4B is a perspective view of the lower housing of the sample handling system of FIG. 3 with a shroud and the housing cover removed.

FIG. 5 is a perspective view of an upper housing of the sample handing system of FIG. 1.

FIG. 6 is a rear perspective view of an assembly of components of the upper housing of FIG. 5.

FIG. 7 is a rear view of the assembly of components of FIG. 6.

FIG. 8 is a top view of the assembly of components of FIG. 6.

FIG. 9 is side view of the assembly of components of FIG. 6.

FIG. 10 is a top view of a portion of components included in the assembly of FIG. 6.

FIG. 11 is a side view of the portion of components of FIG. 10.

FIG. 12 is a perspective view of the portion of components of FIG. 10 with the linear motion member removed.

FIG. 13 is a cross-sectional view of the lower linear motion member portion, the LED assembly, and the PCB of the portion of components of FIG. 10.

FIG. 14 is a perspective view of the tilt member and the sample support member of the portion of components of FIG. 10.

FIG. 15 is a top view of the tilt member of the portion of components shown in FIG. 11.

FIG. 16 is a bottom view of the tilt member of the portion of components shown in FIG. 11.

FIG. 17 is a top view of the lower linear motion member of the portion of components shown in FIG. 11.

FIG. 18 is a bottom view of the lower linear motion member of the portion of components shown in FIG. 11.

FIG. 19 is a top view of the of the upper linear motion member of the portion of components shown in FIG. 11.

FIG. 20 is a bottom view of the upper linear motion member of the portion of components shown in FIG. 11.

FIG. 21 is a schematic view of an embodiment of an alignment mechanism including a multi-arm linkage configured for use in the sample handling system described herein.

FIG. 22 illustrates angled closure of a sample support member and a base member of the sample handling system described herein.

FIG. 23A shows an exemplary sandwiching process where a first substrate (e.g., a slide), including a biological sample, and a second substrate (e.g., array slide) are brought into proximity with one another.

FIG. 23B shows a fully formed sandwich configuration creating a chamber formed from the one or more spacers, the first substrate, and the second substrate.

FIG. 24A shows a perspective view of an exemplary sample handling apparatus in a closed position.

FIG. 24B shows a perspective view of an exemplary sample handling apparatus in an open position.

FIG. 25A shows the first substrate angled over (superior to) the second substrate.

FIG. 25B shows that as the first substrate lowers, and/or as the second substrate rises, the dropped side of the first substrate may contact a drop of reagent medium.

FIG. 25C shows a full closure of the sandwich between the first substrate and the second substrate with one or more spacers contacting both the first substrate and the second substrate.

FIG. 26A shows a side view of the angled closure workflow.

FIG. 26B shows a top view of the angled closure workflow.

FIG. 27 is a schematic diagram showing an example of a barcoded capture probe, as described herein.

FIG. 28 shows a schematic illustrating a cleavable capture probe.

FIG. 29 shows exemplary capture domains on capture probes.

FIG. 30 shows an exemplary arrangement of barcoded features within an array.

FIG. 31A shows and exemplary workflow for performing a templated capture and producing a ligation product.

FIG. 31B shows an exemplary workflow for capturing a ligation product from FIG. 31A on a substrate.

FIG. 32 is a schematic diagram of an exemplary analyte capture agent.

FIG. 33 is a schematic diagram depicting an exemplary interaction between a feature-immobilized capture probe and an analyte capture agent.

### DETAILED DESCRIPTION

Spatial analysis workflows generally involve contacting a sample with an array of features. Aligning a sample with a reagent medium (or, in some embodiments, the array) is an important step in performing spatialomic (e.g., spatial transcriptomic) assays. The ability to efficiently generate robust experimental data for a given sample can depend greatly on the alignment of the sample and the reagent medium (or the array). Traditional techniques require samples to be placed directly onto a reagent medium (or the array). For example, current methods of aligning biological samples with barcoded areas in spatial transcriptomics assays involve a user carefully placing the biological sample onto a substrate that includes a plurality of barcoded probes. This approach can require skilled personnel and additional experimental time to prepare a section of the sample and to mount the section of the sample directly on the reagent medium (or the array). Misalignment of the sample and the reagent medium (or the array) can result in wasted reagent medium (or a wasted array), extended sample preparation time, and inefficient use of samples, which may be limited in quantity.

The systems, methods, and computer readable mediums described herein can enable efficient and precise alignment of samples and arrays, thus facilitating the spatial transcriptomic imaging and analysis workflows or assays described herein. Thus, in some embodiments, an advantage of the devices described is providing an alignment tool for users to align a sample with a barcoded area. Samples, such as portions of tissue, can be placed on a first substrate. The first substrate can include a slide onto which a user can place a sample of the tissue. An array, (e.g., such as a reagent array, or such as a spatially barcoded array) can be formed on a second substrate. The second substrate can include a slide and the array can be formed on the second substrate. The use of separate substrates for the sample and the array can beneficially allow user to perform the spatialomic (e.g., spatial transcriptomic) assays described herein without requiring the sample to be placed onto an array substrate. The sample holder and methods of use described herein can improve the ease by which users provide samples for spatialomic (e.g., spatial transcriptomic) analysis. For example, the systems and methods described herein alleviate users from possessing advanced sample or tissue sectioning or mounting expertise. Additional benefits of utilizing separate substrates for samples and arrays can include improved sample preparation and sample imaging times, greater ability to perform region of interest (ROI) selection, and more efficient use of samples and array substrates. The devices of the disclosure can reduce user error during the assay analysis, thereby also reducing sample analysis costs. In some embodiments, another advantage of the devices of the disclosure is a reduction in the number of aberrations or imaging imperfections that may arise due to user error in aligning a biological sample with a barcoded area of the substrate. In some embodiments, the devices of the disclosure allow for pre-screening of samples for areas of interest. In some embodiments, the devices of the disclosure allow for archived samples to be examined.

The sample substrate and the array substrate, and thus, the sample and the array, can be aligned using the instrument and processes described herein. The alignment techniques and methods described herein can generate more accurate spatialomic (e.g., spatial transcriptomic) assay results due to the improved alignment of samples with an array (e.g., such as a reagent array, or such as a spatially barcoded array).

In some embodiments, a workflow described herein comprises contacting a sample disposed on an area of a first substrate with at least one feature array of a second substrate. In some embodiments, the contacting comprises bringing the two substrates into proximity such that the sample on the first substrate may be aligned with the barcoded array on the second substrate. In some instances, the contacting is achieved by arranging the first substrate and the second substrate in a sandwich assembly. In some embodiments, the workflow comprises a prior step of mounting the sample onto the first substrate.

Alignment of the sample on the first substrate with the array on the second substrate may be achieved manually or automatically (e.g., via a motorized alignment). In some aspects, manual alignment may be done with minimal optical or mechanical assistance and may result in limited precision when aligning a desired region of interest for the sample and the barcoded array. Additionally, adjustments to alignment done manually may be time-consuming due to the relatively small time requirements during the permeabilization step.

It may be desirable to perform real-time alignment of a tissue slide (e.g., a first substrate) with an array slide (e.g., a second substrate). In some implementations, such real-time alignment may be achieved via motorized stages and actuators of a sample handling system as described herein.

In some instances, the first substrate and the second substrate are arranged in a sandwich assembly, e.g., as described herein. It is noted that the terms first substrate and second substrate do not necessarily connote the particular order or location of the biological sample or capture probes. For example, in one instance, the first substrate includes the biological sample and the second substrate includes capture probes. In another instance, the first substrate includes capture probes and the second substrate includes the biological sample. In some embodiments, the tissue permeabilization process begins when the sample is contacted with the permeabilization buffer. During the permeabilization process, analytes are released from the sample. In some embodiments, analytes that are released from the permeabilized sample diffuse to the surface of the second substrate and are captured on the feature array (e.g., on barcoded probes). In some instances, there is a gap between the first and the second substrate. In some instances, the gap is about 1, 2, 2.5, 3, 4, 5, 6, 7, 8, 9, 10, 11, 12, 12.5, 13, 14, 15, 16, 17, 18, 19, 20, 21, 22, 23, 24, 25 μm or more. In some embodiments, second substrate is placed in direct contact with the sample on the first substrate ensuring no diffusive spatial resolution losses. In some embodiments, an alignment mechanism is configured to maintain a separation between the first and second substrates when the first and second substrates are aligned. In some embodiments, the alignment mechanism is configured to maintain the separation such that at least a portion of the sample on the first substrate contacts at least a portion of the reagent medium on the second substrate. In some embodiments, the separation between the first and second substrates is between 2 microns and 1 mm, measured in a direction orthogonal to a surface of the first substrate that supports the sample. In some instances, the first substrate and the second substrate are separated (e.g., pulled apart). In some embodiments, the sample analysis (e.g., cDNA synthesis) can be performed on the first substrate after the first substrate and the second substrate are separated. In some embodiments, the substrate comprising the biological sample can be discarded or archived after the first substrate and the second substrate are separated.

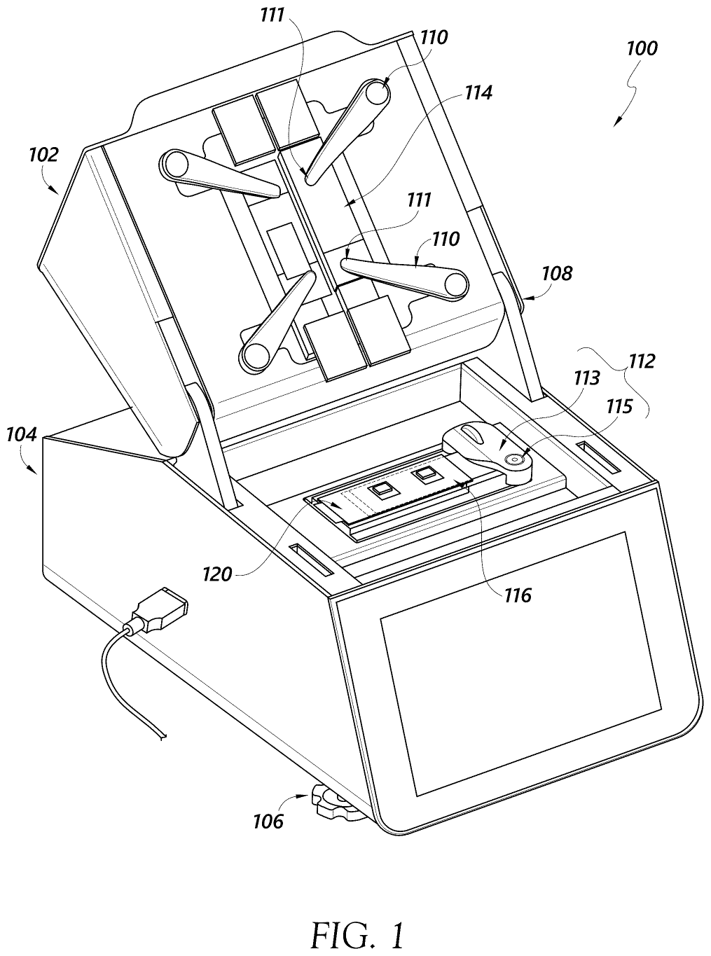

FIG. 1 shows a perspective view of an example embodiment of a sample handling system (SHS) 100 in accordance with some example implementations described herein. As shown, the SHS 100 includes an upper housing 102 and a lower housing 104. The SHS 100 can be provided on a suitable working surface, such that the lower housing 104 can contact the working surface via a plurality of feet 106 configured to extend from a bottom surface of the lower housing 104. In various embodiments, the plurality of feet 106 are adjustable such that a height of each foot 106 may be adjusted in the z-direction to prevent rocking of the SHS 100. In various embodiments, the plurality of feet 106 have vibration dampening features. For example, the plurality of feet 106 may include a vibration dampening material (e.g., rubber) or may include vibration dampening mechanisms (e.g., one or more springs, one or more dampeners, one or more motion actuators such as a piezoelectric actuator, and/or one or more motion controllers). The upper housing 102 and the lower housing 104 can be connected at an alignment mechanism 108, such as a hinge, to allow the upper housing 102 to actuate from an open configuration (that permits loading of one or more sample slides and/or a capture array slide) to a closed configuration (that permits alignment of the sample slides and capture array slide). For example, the upper housing 102 may be rotated open and/or rotated closed with respect to the lower housing 104. In various embodiments, when in the closed configuration, a sample support member 140 (onto which sample substrates are positioned and retained) has a predetermined spacing from a base support member 120. The alignment mechanism 108 may be configured to allow the upper housing 102 to be positioned in an open configuration (as shown in FIG. 1) or in a closed configuration by opening or closing (e.g., via rotation) the upper housing 102 relative to the lower housing 104 in a clamshell manner via the alignment mechanism 108. It will be understood that in the closed configuration, the upper housing 102 is brought into contact with the lower housing 104 such that the upper housing 102 rests atop the lower housing 104 and the sample support member 140 is positioned opposite the base support member 120. In various embodiments, the lower housing 104 has a well (e.g., an extruded cut forming a depressed area in the lower housing 104) and a raised lip defining a perimeter around the well. In various embodiments, the base support member 120 extends from a base of the well. In various embodiments, the base support member 120 extends to a lesser height compared to a height of the lip (does not extend to the same height as the lip) so that, when the upper housing 102 and the lower housing 104 are in the closed configuration, a gap is formed between the one or more sample slides positioned on the upper support member(s) and a capture array slide positioned on the base support member 120.

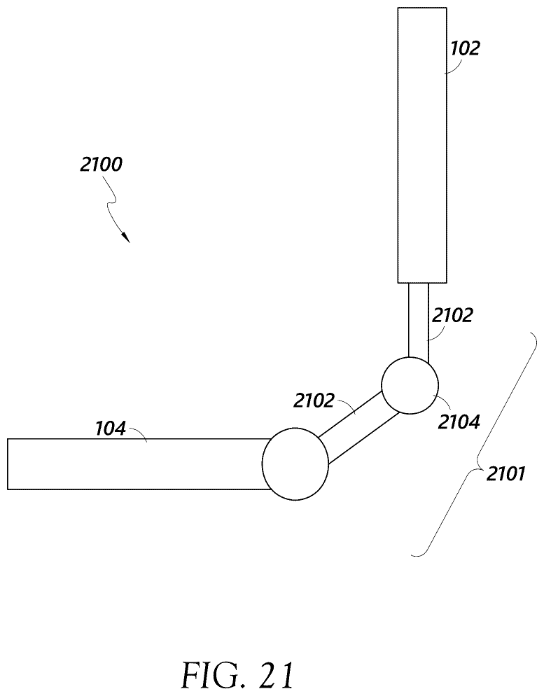

In some embodiments, the alignment mechanism 108 is configured as a multi-arm linkage, such as the multi-arm linkage 2101 shown in a schematic side view of a sample handling system 2100 illustrated in FIG. 21. In various embodiments, the multi-arm linkage 2101 is configured to perform a more-complicated motion compared to a hinge having a single rotational axis, such as the configuration of the alignment mechanism 108 shown in FIGS. 1-3. In certain embodiments, alignment mechanism 2101 can include at least one arm. For example, as shown in FIG. 21, arms 2102 can be connected to upper and lower housings 102 and 104. In various embodiments, the arms 2102 can includes an internal pivoting mechanism 2104 (e.g., a pin, a hinge, or the like) that allows the arms 2102 to fold, bringing housings 102 and 104 into alignment. Although only one arm 2102 is shown in FIG. 21 adjacent and coupled to the internal pivoting mechanism 2104, the multi-arm linkage 2102 can include multiple arms 2102 (e.g., 2 or more, 3 or more, 4 or more, or even more arms 2102).

In various embodiments, the upper housing 102 includes one or more first retaining mechanisms 110 and the lower housing 104 includes one or more second retaining mechanisms 112. The first retaining mechanisms 110 can be configured to retain one or more first substrates 114 (e.g., sample substrates). In FIG. 1, the upper housing 102 is configured to retain two sample substrates (e.g., within the first retaining mechanisms 110), however the upper housing 102 may be configured to retain more (e.g., 3, 4, 5, or more) or fewer (e.g., 1) sample substrates. As further shown in FIG. 1, the SHS 100 includes a second retaining mechanism 112 including a spring-loaded member 113. In various embodiments, the second retaining mechanism 112 is disposed on the lower housing 104 and is configured to receive and secure a second substrate 116 (e.g., a capture array substrate/slide) to the lower housing 104. In various embodiments, the second retaining mechanism 112 includes a spring-loaded member 113 and a spring 115 (or the like) configured within the spring-loaded member 113 such that the spring-loaded member 113 is rotationally pivoted toward or away from the second substrate 116 via the spring 115. The spring-loaded member 113 can be configured to provide a force against the second substrate 116, such that, when a substrate (e.g., a glass slide) is positioned against the second retaining mechanism 112, the second substrate 116 is retained within the base support member 120. In some embodiments, the second substrate 116 can include an array substrate as described herein.

In various embodiments, the first retaining mechanism 110 includes at least one clip 111 (e.g., each first retaining mechanism has a clip). In some embodiments, the first retaining mechanism 110 includes a spring (or the like) configured to ensure the clip 111 maintains contact with the first substrate 114. In some embodiments, the clip 111 is pre-biased such that the clip provides a force against the sample support member 140 even without the first substrate 114 positioned thereon.

In some aspects, when the SHS 100 is in an open position (as in FIG. 1), the first substrate 114 and/or the second substrate 116 may be loaded and positioned within the SHS 100 such as within the upper housing 102 and the lower housing 104, respectively. As noted, the alignment mechanism 108 may allow the upper housing 102 to close over and onto the lower housing 104 such that the one or more substrates on the sample support member 140 are at a first distance from the one or more substrates on the base support member (and the one or more sample support members 140 have a larger distance from the base support member). In various embodiments, when in the closed configuration, the upper housing 102 contacts the lip (e.g., a portion of or an entirety of the lip) of the lower housing 104. In various embodiments, the upper housing 102 is configured to sandwich the first substrate 114 and the second substrate 116 by bringing the first substrate(s) and the second substrate(s) into close proximity and/or contact with one another.

In some aspects, after the upper housing 102 closes over and onto the lower housing 104, an adjustment mechanism of the sample handling system 100 actuates portions of the upper housing 102 and/or the lower housing 104 (e.g., at least one sample support member 140 and/or the base support member 120) to adopt a sandwich configuration for a permeabilization step. For example, the adjustment mechanism involves bringing the at least one first substrate 114 and the second substrate 116 close to one other (e.g., via a linear actuator that actuates the sample support member 140 towards the base support member 120). In some aspects, the adjustment mechanism actuates the sample support member 140 and/or the base support member 120. The adjustment mechanism may be configured to control a speed, an angle, or the like of the sandwich configuration. In various embodiments, the adjustment mechanism includes a linear actuator. In various embodiments, the linear actuator includes a screw-driven actuator, a solenoid, a stepper motor, a hydraulic actuator, a pneumatic actuator, and/or a piezoelectric actuator.

In some embodiments, a tissue sample on the first substrate 114 is secured within the upper housing 102 (e.g., via the first retaining mechanism 110) prior to closing the upper housing 102 onto the lower housing 104, such that a desired region of interest of the sample is aligned with a capture array of the second substrate 116, e.g., when the first and the second substrates are aligned in the sandwich configuration. Such alignment may be accomplished manually (e.g., by a user) or automatically (e.g., via an automated mechanism). In various embodiments, before alignment, one or more spacers are applied to the first substrate 114 and/or the second substrate 116 to maintain a minimum spacing between the first substrate 114 and the second substrate 116 during sandwiching. In some aspects, a reagent (e.g., a permeabilization solution and/or an analyte transfer medium) is applied to the first substrate 114 and/or the second substrate 116. For example, one or more drops of a reagent is dispensed on one or more spacer (e.g., one drop for each capture area) that is adhered to the capture array slide. The upper housing 102 may then close over the lower housing 104 and form the sandwich configuration, thereby contacting the sample substrate(s) and capture area with the reagent (and providing a liquid medium between the samples and the capture areas). Analytes (e.g., mRNA transcripts, proteins, etc.) may migrate from the permeabilized sample on the first substrate 114 captured by capture probes on the second substrate 116 to be processed for spatial analysis.

In some embodiments, after the upper housing is in the closed configuration, an image capture device may capture one or more images of the overlap area between the tissue sample and the capture probes. If more than one first substrates 114 and/or second substrates 116 are present within the SHS 100, the image capture device may be configured to capture one or more images of one or more overlap areas (for example, the SHS 100 may have two or more cameras, and each camera is directed at a unique capture area on the second substrate).

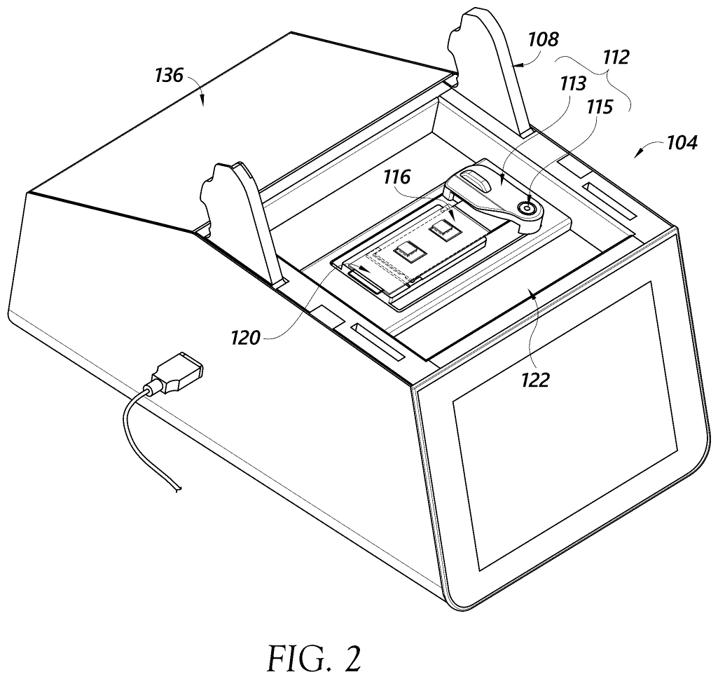

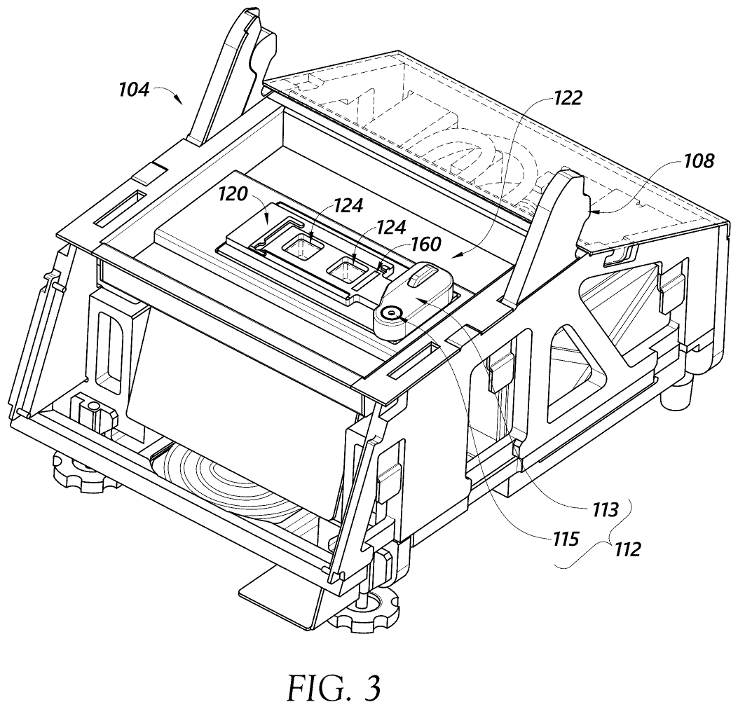

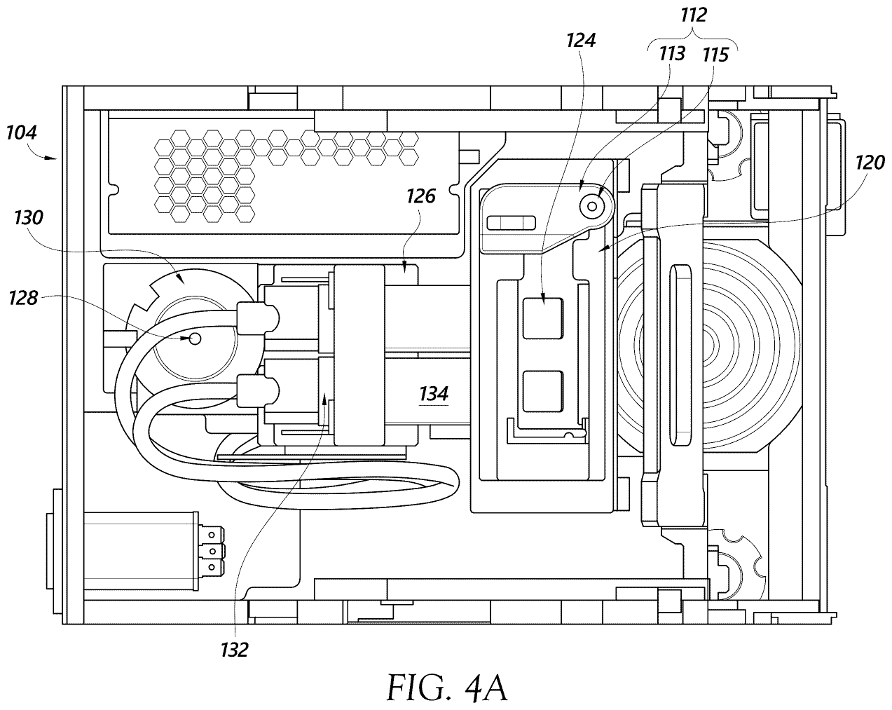

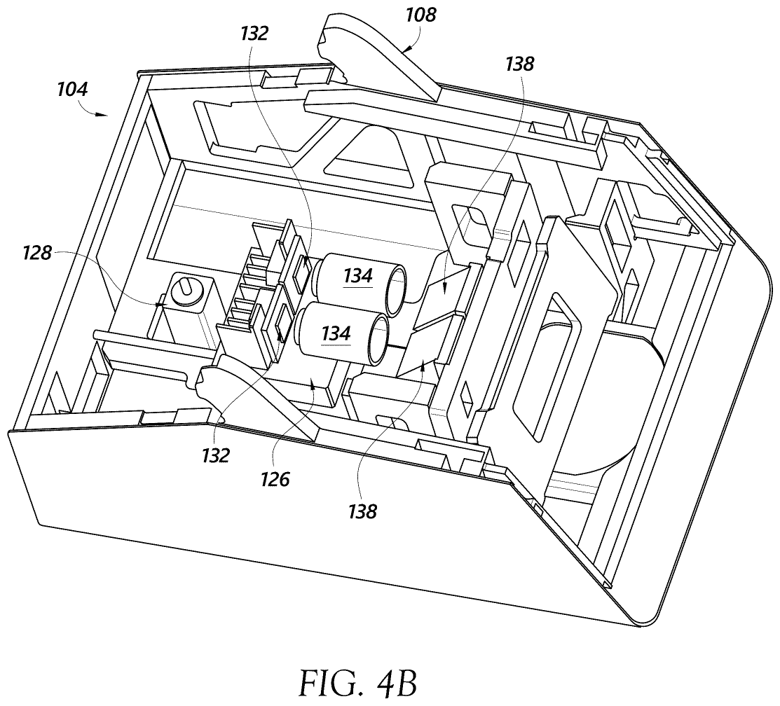

FIGS. 2-4B illustrate the lower housing 104 of the SHS 100 described in relation to FIG. 1. The housing cover 136 of the lower housing 104 has been removed in FIGS. 3-4B. As shown in FIGS. 2-4B, the lower housing 104 includes a base support member 120 configured atop a shroud 122 of the lower housing 104. In various embodiments, the base support member 120 operates in conjunction with the second retaining mechanism 112 to retain a substrate 116 upon the base support member 120. In various embodiments, the base support member 120 includes one or more base windows 124. In various embodiments, the base windows 124 are in alignment with corresponding sample windows provided on sample support members 140 that are arranged in the upper housing 104 (and the upper housing 102 and lower housing 104 are in the closed configuration).

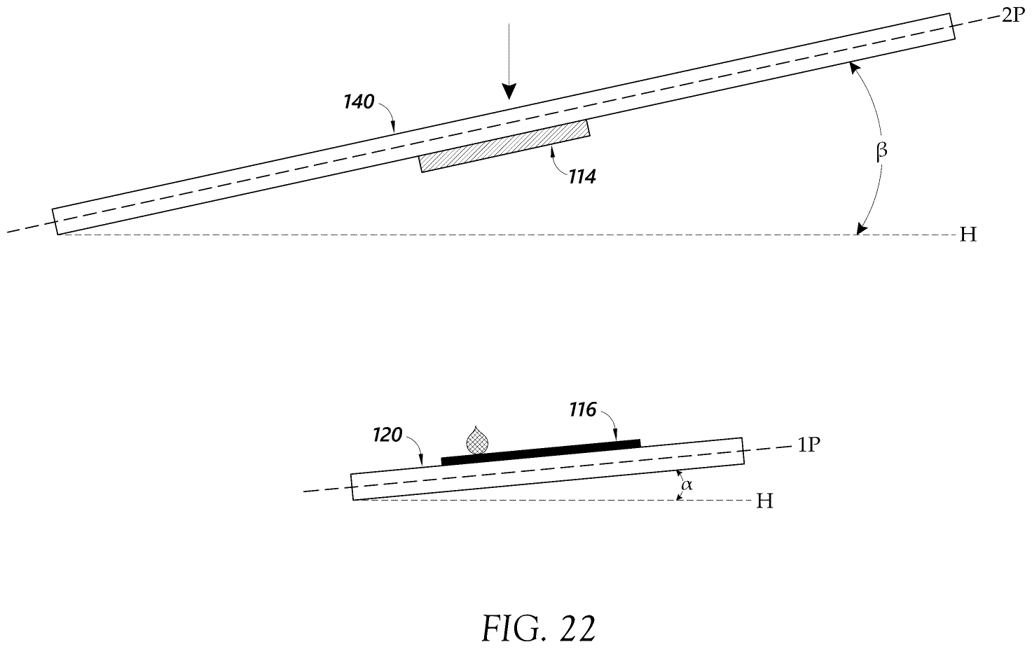

In various embodiments, the base support member 120 defines a first plane 1P at a first angle α relative to a horizontal plane H when in the closed configuration (but not yet actuated into the sandwiched configuration), as shown in FIG. 22. In various embodiments, the first angle α is about 3 degrees, although other angles can be envisioned. In various embodiments, the first angle α is about 0.5 degree to about 30 degrees. For example, in some embodiments, the first angle α can be about 0.5, 1.0, 1.5, 2.0, 2.5, 3.0, 3.5, 4.0, 4.5, or 5.0 degrees relative to a horizontal plane. For example, as shown in FIG. 22, the base support member 120 defines a first plane 1P and includes a substrate 116 having a barcoded capture array thereon. In various embodiments, the base support member 120 is positioned at the first angle α relative to the horizontal plane H. In various embodiments, the sample support member 140 defines a second plane 2P at an angle β relative to the horizontal plane H (thus having a second angle between second plane 2P and first plane 1P). In various embodiments, the second angle is determined as β minus α. In some embodiments, the angle β can be about 7 degrees, although other angles can be envisioned. In various embodiments, the angle β is about 1 degree to about 45 degrees. In some embodiments, the second angle can be about 0.5, 1.0, 1.5, 2.0, 2.5, 3.0, 3.5, 4.0, 4.5, 5.0, 5.5, 6.0, 6.5, 7, 7.5, 8, 8.5, 9, 9.5, or 10 degrees.

As shown in FIG. 4A, the shroud 122 has been removed to show a top-view internal components of the lower housing 104 (in a plan view). The lower housing 104 includes a focus stage 126 which can translate linearly toward or away from the base support member 120 (when viewed in the plan view). In various embodiments, the focus stage 126 is translated via actuation of a motor 128 (e.g., a stepper motor) configured to cause a cam wheel 130 to rotate so as to move the focus stage 126 toward or away from the base support member 120 relative to a horizontal plane on which the SHS 100 is placed. In various embodiments, the cam wheel 130 is coupled to a roller (not shown) that causes the focus stage to translate. In various embodiments, the roller is threaded. In various embodiments, the cam wheel 130 has a first diameter and the roller has a second diameter thereby defining a gear ratio between the motor 128 and the roller. As further shown in FIGS. 4A and 4B, the focus stage 126 includes at least one image sensor 132 and at least one lens or objective 134 associated with each image sensor 132 and positioned on the stage 126. As shown in FIG. 4B, the base support member 120 and the cam wheel 130 have been removed to better illustrate the positioning of the motor 128, the image sensors 132, and the lenses 134. In addition, the lower housing 104 can also include one or more mirrors 138 configured to reflect light, from an LED assembly configured in the upper housing 102 which will be described later, toward the lenses 134 and the image sensors 132. In some embodiments, the mirrors 138 are right-angle prisms, as shown in FIG. 4B.

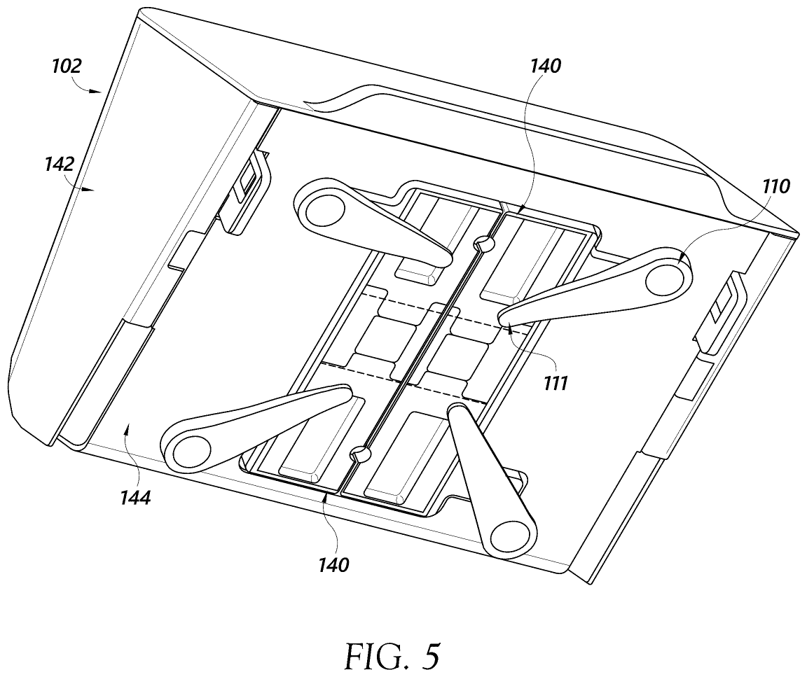

Returning to the upper housing 102 of the SHS 100 described herein, as shown in FIG. 5, the upper housing 102 includes a housing cover 142 and a shroud 144 enclosing the upper housing 102. As described above, the upper housing 102 also includes one or more sample support members 140. In various embodiments, each sample support member 140 is configured to receive and retain a first substrate 114 (e.g., a sample substrate) therein. In various embodiments, the retaining mechanisms 110 are configured to apply a force onto the first substrate 114 so as to maintain the first substrate 114 within the sample support member 140.

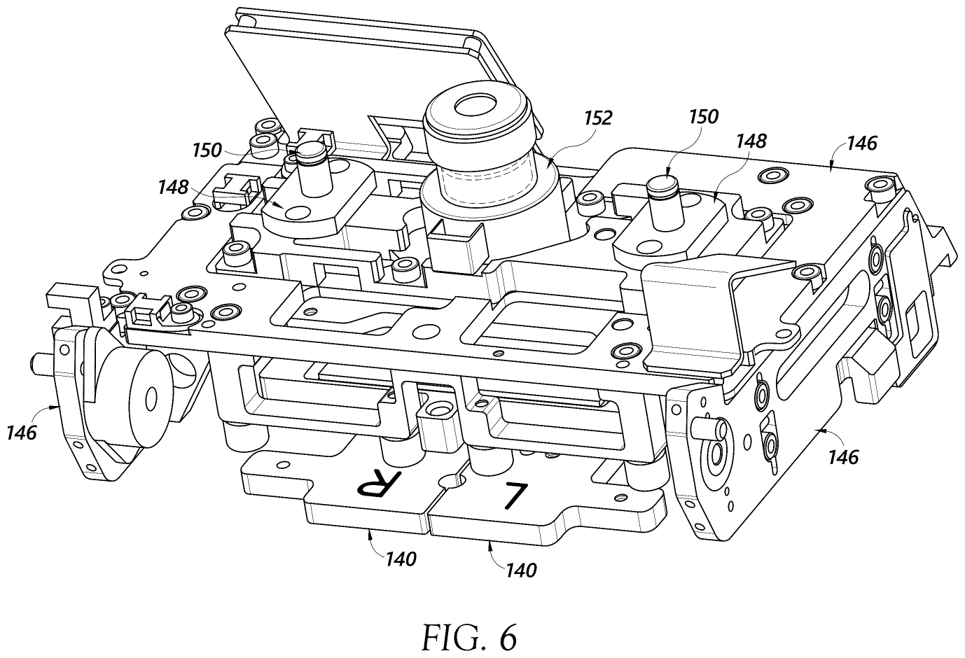

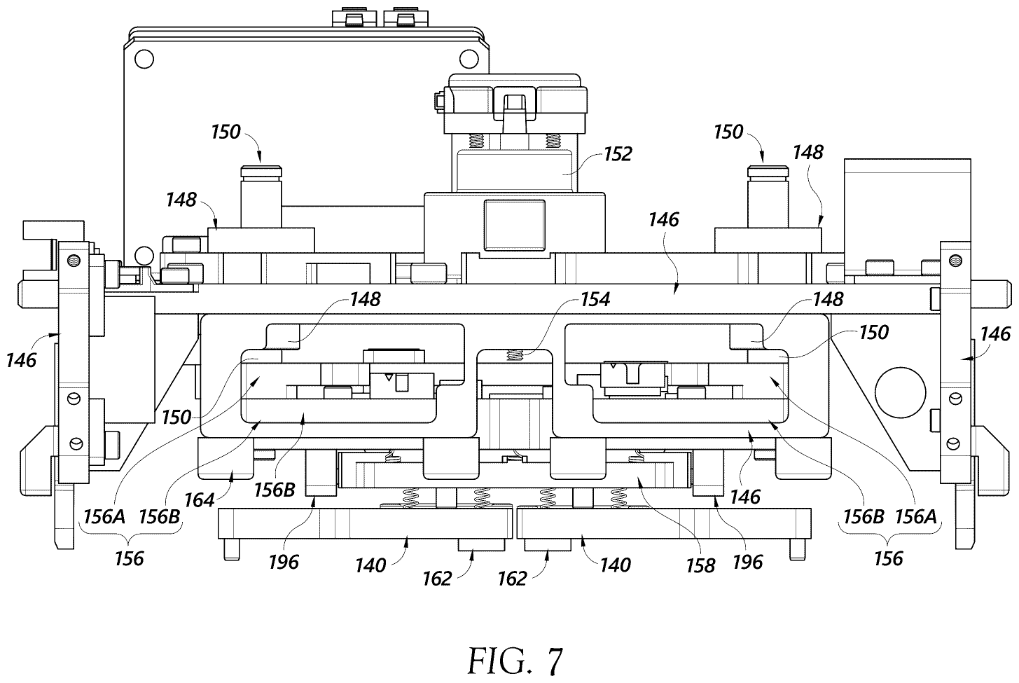

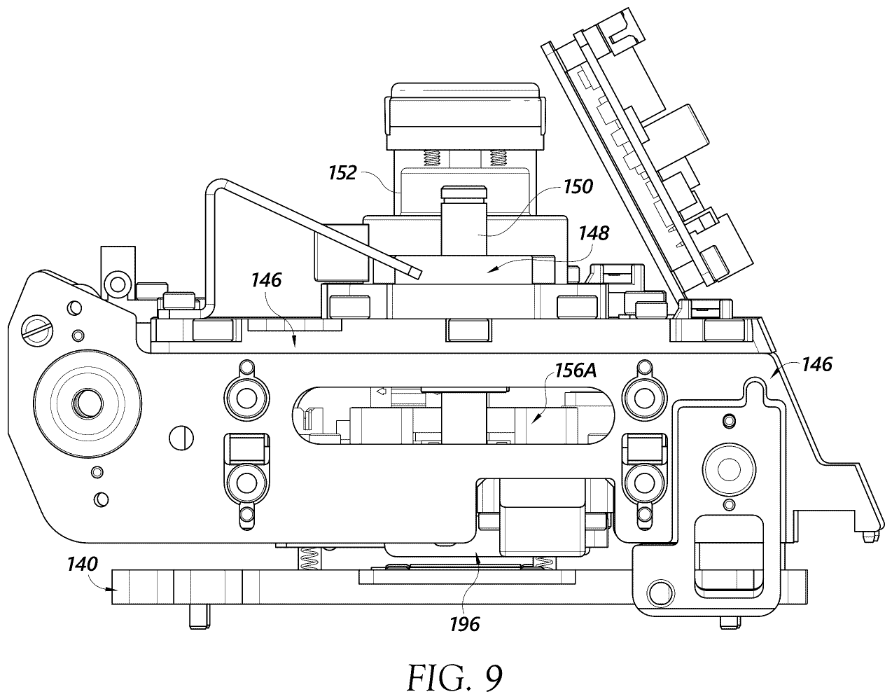

With the housing cover 142 and the shroud 144 removed as shown in FIGS. 6-9, additional detail of components of the upper housing 102 can be viewed. For example, as shown in FIG. 6, the upper housing 102 includes a frame 146. In various embodiments, the frame 146 includes at least one bushing 148 and at least one shaft 150 positioned within the bushing 148 such that each shaft 150 is constrained to slide along an axis defined by the bushing. In various embodiments, the upper housing 102 includes a linear actuator 152 mounted on the frame 146. In various embodiments, a coupling 154, such as a threaded rod positioned in a bore and bolts on either side, couples the linear actuator 152 to an upper linear motion member 156A of a linear motion member 156. In various embodiments, the linear motion member 156 further includes a lower linear motion member 156B coupled to the upper linear motion member 156A. In various embodiments, a tilt member 158 is rotatably coupled to the lower linear motion member 156B as shown in FIG. 7 and will be described in more detail later. In various embodiments, the sample support members 140 are coupled to the tilt member 158.

In various embodiments, the linear actuator 152 is configured to actuate the linear motion member 156, the tilt member 158 and the sample support members 140 vertically (e.g., up and down as viewed in the plane of the page of FIG. 7), via the coupling means 154, in order to bring the sample substrate holders 140 (and thus the first substrates 114) into proximity and/or contact with the substrate 116 configured in the lower housing 104 when the upper housing 102 and the lower housing 104 are in the closed configuration. In some embodiments, the base support member 120, the sample support members 140, and/or the substrates (sample substrates and/or substrate with the barcoded capture array) can include a spacer configured thereon to maintain a predetermined distance between the sample support member 140 and the base support member 120 after the linear actuator 152 translates the sample support members 140 toward the base support member 120 (during the sandwiching process). For example, a spacer 160 can be provided on the base support member 120 as shown in FIG. 3 and a spacer 162 can be provided on the sample support members 140 as shown in FIG. 7. The spacers 160 and 162 can be provided on the base support member 120 and/or the sample support members 140, respectively, in a variety of locations thereof and need not be limited to the locations of spacers 160 and 162 as shown in FIGS. 3 and 7. For example, in some embodiments, the spacers 160 and/or 162 can be positioned at one or more locations. In other embodiments, the spacers 160 and/or 162 can be positioned to surround the base windows 124 and/or the sample windows 166, respectively. In another example, a spacer is provided on the substrate having the barcoded array and/or substrate(s) having samples positioned thereon. The frame 146 can also include one or more stoppers 164 arranged thereon to limit an angular range of motion of the sample support members 140. In various embodiments, the spacer is a separate component and is removably positioned on a substrate prior to sandwiching (actuating the sample support members to bring the sample and barcoded capture array closer together). In various embodiments, the spacer is formed of a material deposited on a substrate (and becomes an integral part of the substrate). In various embodiments, the spacer substantially surrounds each barcoded capture array. In various embodiments, the spacer includes at least one well configured to receive a volume of a reagent.

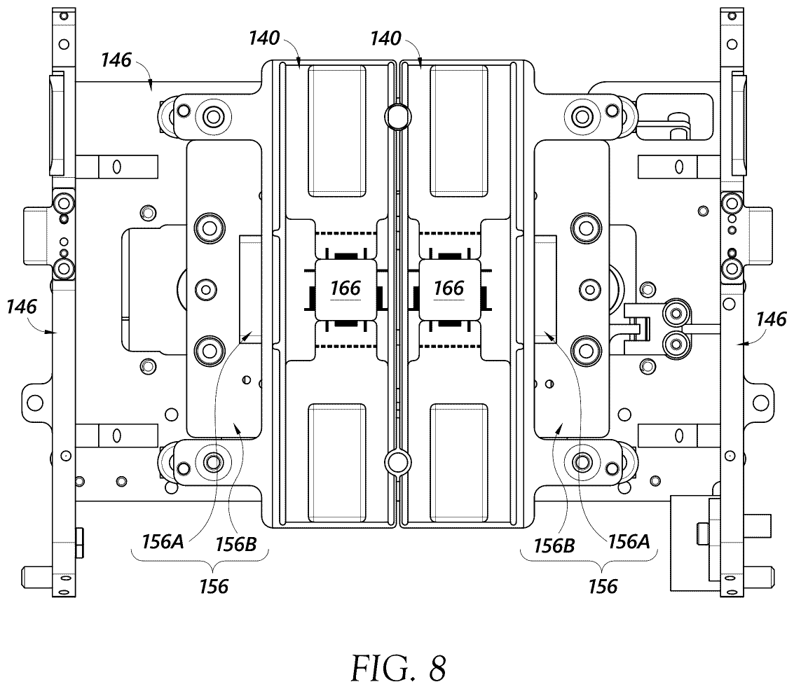

As shown in FIG. 8, each of the sample support members 140 includes a sample window 166. In various embodiments, the sample window 166 is aligned with the base windows 124 when the upper housing 102 and the lower housing 104 are in the closed configuration. For example, after the sandwiching operation is complete and the sample substrate contacts the spacer and/or the substrate having the barcoded capture array, each sample window 166 aligns with a respective base window 124 to allow for illumination and imaging of each sample.

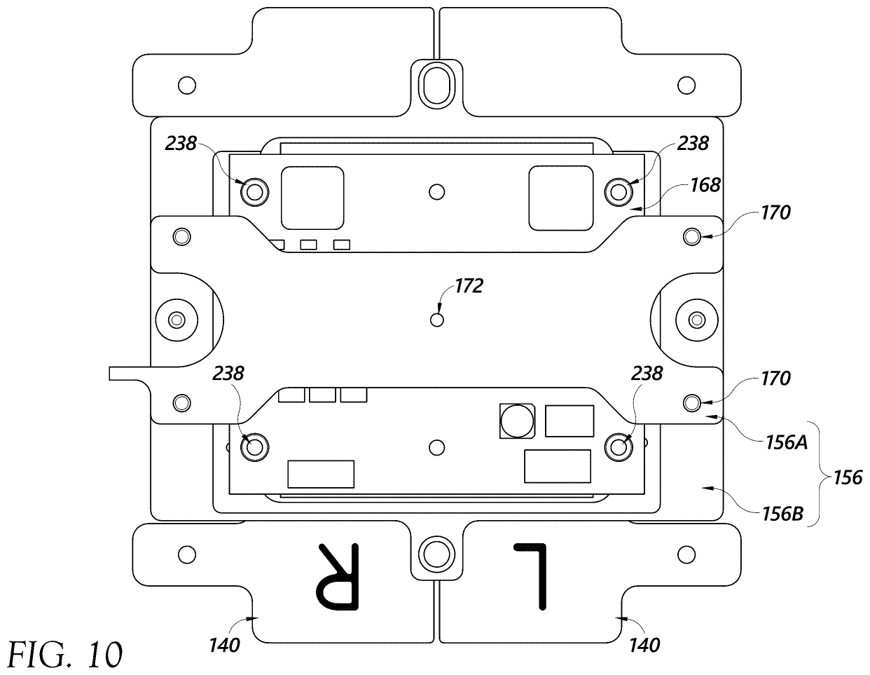

In various embodiments, a printed circuit board (PCB) 168 is positioned between upper linear motion member 156A and the lower linear motion member 156B as shown in FIG. 10. In various embodiments, the PCB 168 includes one or more light emitting diodes. In various embodiments, the upper linear motion member 156A is coupled to the lower linear motion member 156B by one or more attachment means 170. For example, as shown in FIG. 10, one or more bolts 170 are provided through the lower linear motion member 156B and received within the upper linear motion member 156A. As further shown in FIG. 10, the upper linear motion member 156A includes a receiving element 172, such as a threaded bore, by which the coupling means 154 can be received so as to couple the upper linear motion member 156A to the linear actuator 152.

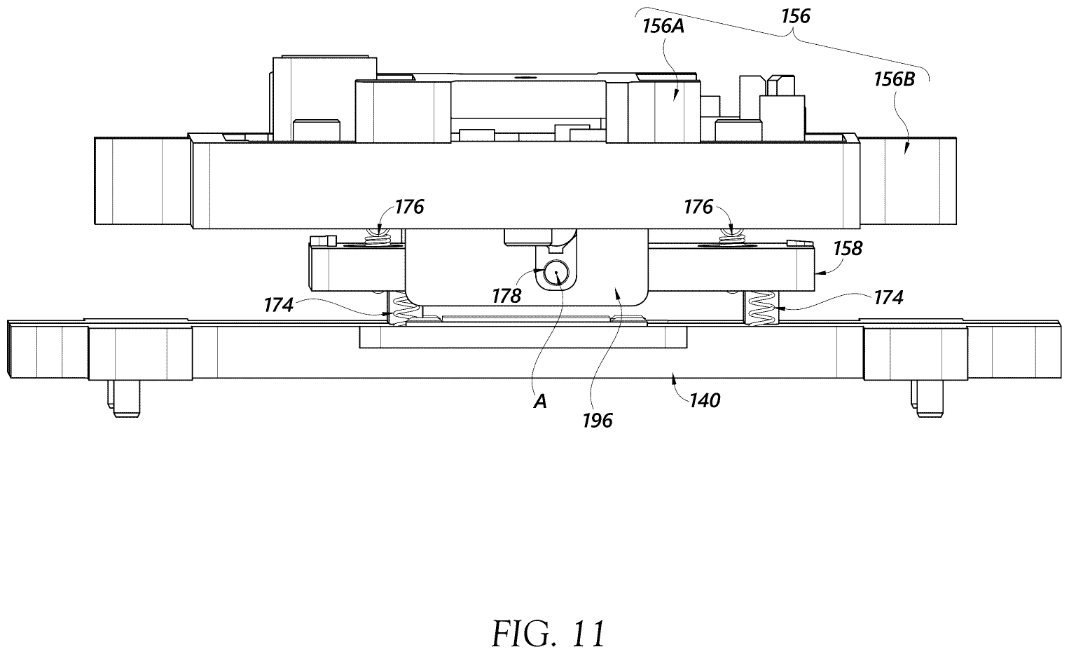

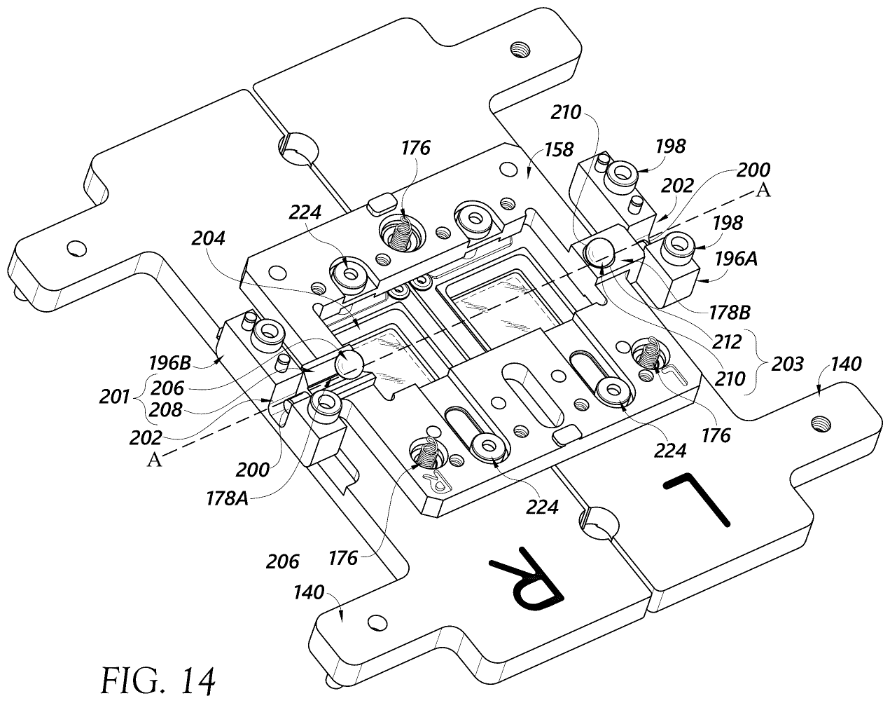

As shown in FIG. 11, the sample support members 140 are coupled to the tilt member 158 via one or more compression springs 174. In various embodiments, the tilt member 158 is coupled to the lower linear motion member 156B via one or more tension springs 176. In various embodiments, the tilt member 158 is further coupled to the linear motion member 156 (e.g., the lower linear motion member 156B) at pivot 178. A rotational axis A extends between the two pivots 178 as shown in FIGS. 11 and 14 and the tilt member 158 can rotate about the axis A.

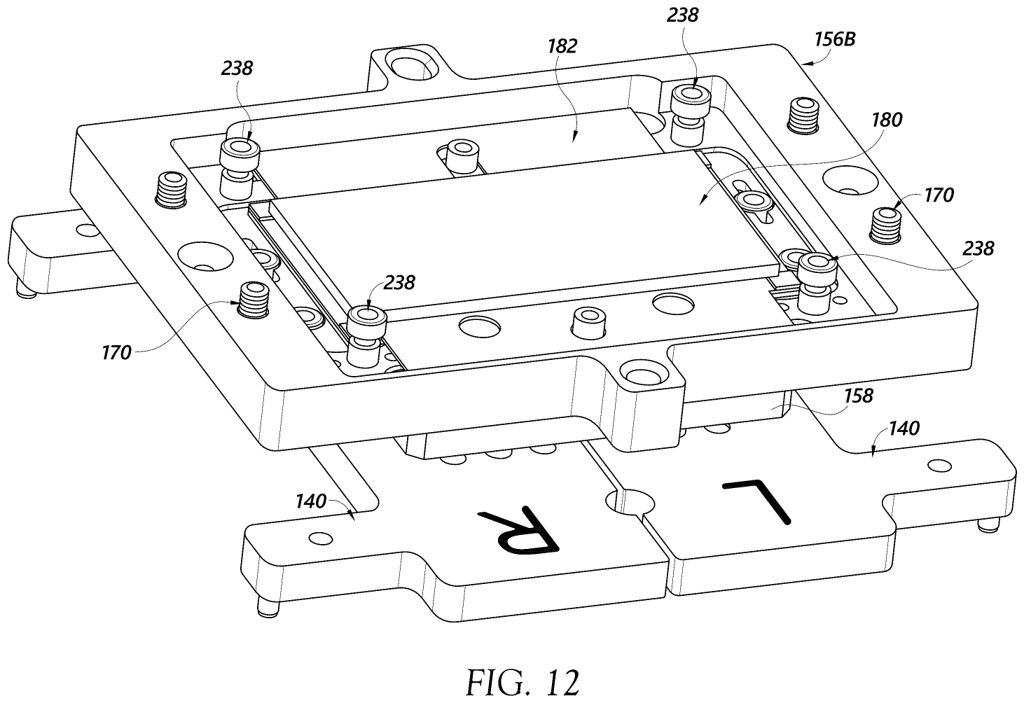

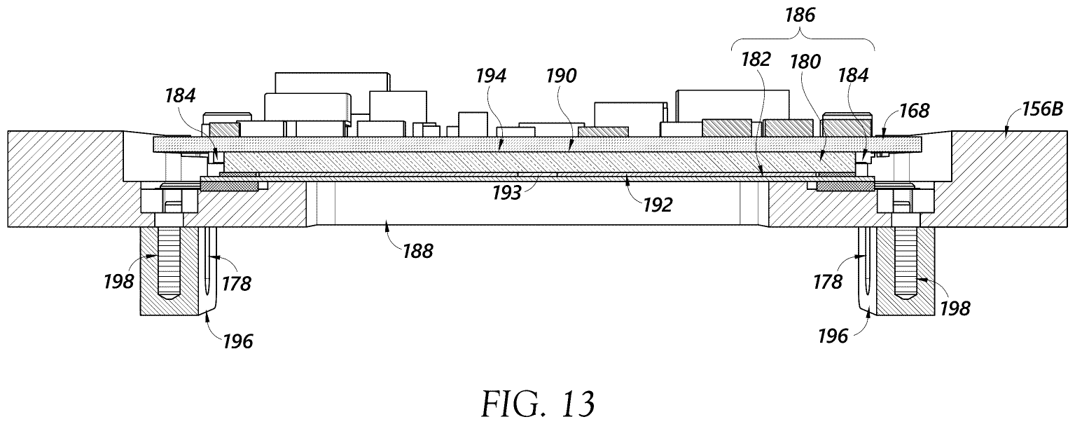

As shown in FIGS. 12 and 13, the upper housing 102 can also include a light emitting diode (LED) assembly 186. In various embodiments, the LED assembly 186 is configured to provide light through an aperture 188 of the lower linear motion member 156B as shown in FIG. 13. In various embodiments, the LED assembly 186 is positioned within a recess of the lower linear motion member 156B. In various embodiments, the LED assembly 186 is positioned to substantially extend across the entire aperture 188 (i.e., an area of illumination of the LED assembly substantially equals or is greater than an area of the aperture). In various embodiments, the LED assembly 186 is positioned below the PCB 168 as shown in FIG. 13. In various embodiments, the LED assembly 186 includes a light guide 180, a diffuser 182 positioned below the light guide 180, and one or more LEDs 184 arranged around a periphery of the light guide 180, such as adjacent to a side wall or a side surface of the light guide 180. In various embodiments, an area of the light guide 180 is substantially equal to or greater than an area of the aperture 188, although in some embodiments, the area of the light guide 180 can be greater than or less than the area of the aperture 188.

In various embodiments, the light guide 180 includes atop surface 190 that is opposite a bottom surface 192. In various embodiments, the diffuser 182 is positioned at a predetermined distance from the bottom surface 192. In various embodiments, the diffuser 182 is positioned in contact with the bottom surface 192. In various embodiments, the diffuser 182 can be spaced apart from the light guide 180. The diffuser 182 can include an aperture in which a cylindrical threaded bushing 193 can be positioned. The bushing 193 can extend from the lower linear motion member 156B toward the PCB 168. A screw or similar attachment means can be received through a hole in the PCB 168 into the bushing 193. In various embodiments, the top surface 190 includes a reflective layer 194 configured to reflect light emitted from the LEDs 184 (and transmitted into the light guide 180) through the bottom surface 192, the diffuser 182, and into the aperture 188. In various embodiments, the reflective layer 194 includes a metal. For example, the reflective layer may include a metal sheet or metal film. In some embodiments, the reflective layer 194 can include a coating. For example, the reflective layer 194 can include a silvered surface. As another example, the reflective layer 194 may include a sputtered metal coating. In some embodiments, the coating can include nanoparticles that can be disposed in a matrix. For example, the nanoparticles can include metallic oxide nanoparticles, such as aluminum oxide nanoparticles or titanium dioxide nanoparticles. In some embodiments, the mean diameter of the nanoparticles is less than or equal to 600 nanometers, although other diameter sizes can be envisioned. In some embodiments, the matrix includes an epoxy polymer.

In various embodiments, the tilt member 158 is rotatably coupled to the lower linear motion member 156B via a plurality of arms 196, such as arms 196A and 196B as shown in FIG. 14. In various embodiments, the arms 196 are coupled to the lower linear motion member 156B via bolts 198 as shown in FIGS. 13 and 14. In various embodiments, the arms 196 are integral parts of the lower linear motion member 156. In various embodiments, the arms 196 are shaped such that the slots 202 are formed therein. In various embodiments, the tilt member 158 includes at least two pins 200. In various embodiments, the pins 200 are seated within slots 202 of the arms 196 to allow the tilt member 158 to rotate with respect to the slots 202 along axis A (and thus the lower linear motion member 156B). In various embodiments, the tilt member 158 includes at least one pivot. For example, the tilt member 158 includes two pivots 178A, 178B. In various embodiments, the pivots 178A, 178B are positioned along axis A. In various embodiments, at least one pivot, e.g., the first pivot 178A, includes a ball-in-slot joint 201 (which allows for rotation and some translational motion, e.g., translation along a single axis A). In various embodiments, at least one pivot, e.g., the second pivot 178B, includes a ball joint 203 (which constrains all translational motion but allows for rotation, e.g., yaw, pitch, and/or roll). As shown in FIG. 14, the first pivot 178A includes a ball 206 arranged within a slot 208 and the second pivot 178B includes a ball 210 positioned within a recession 212 (and/or a through-bore). In various embodiments, the recession is spherical-shaped.

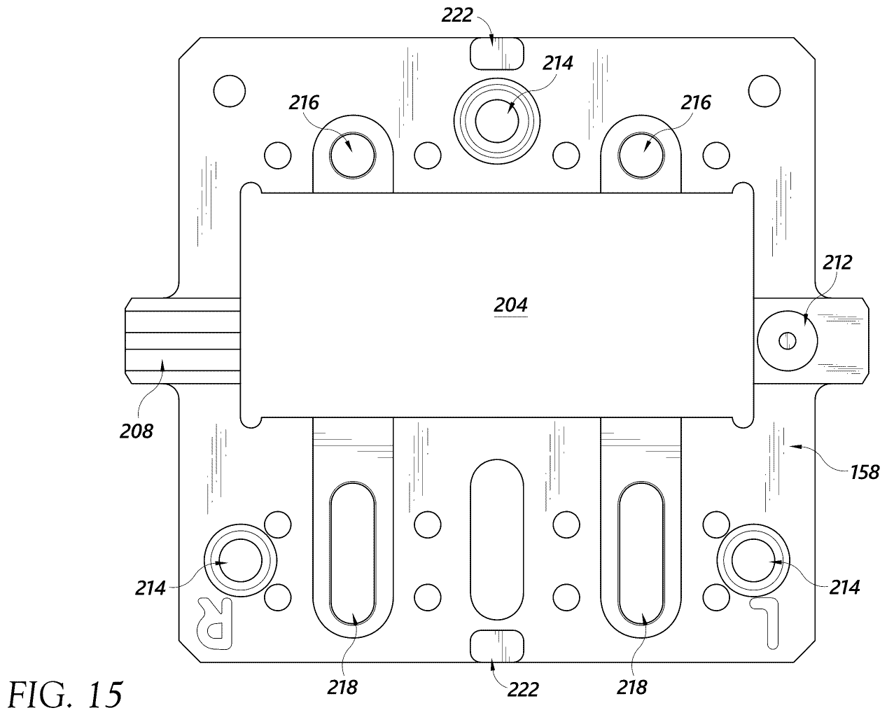

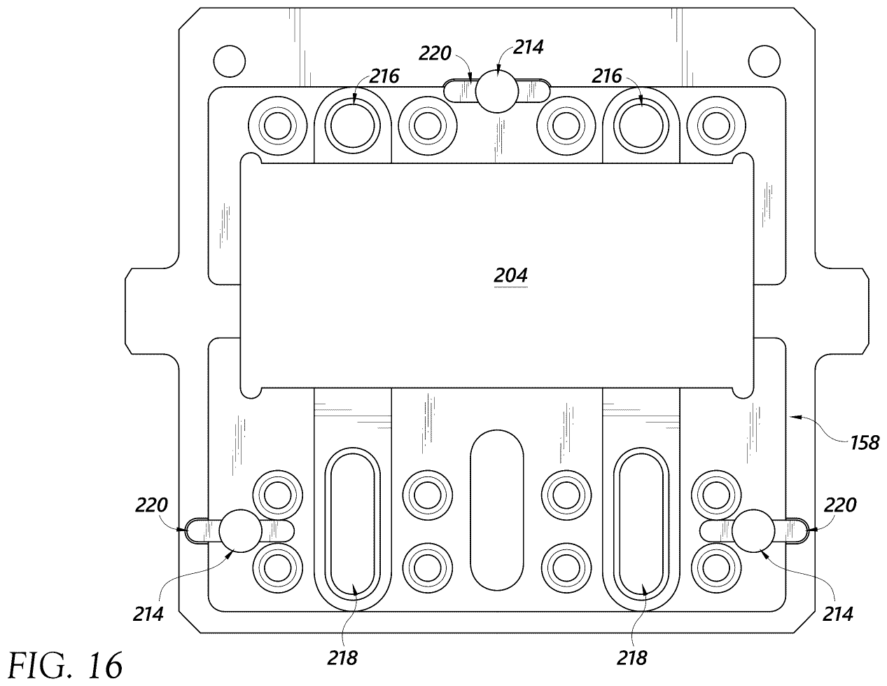

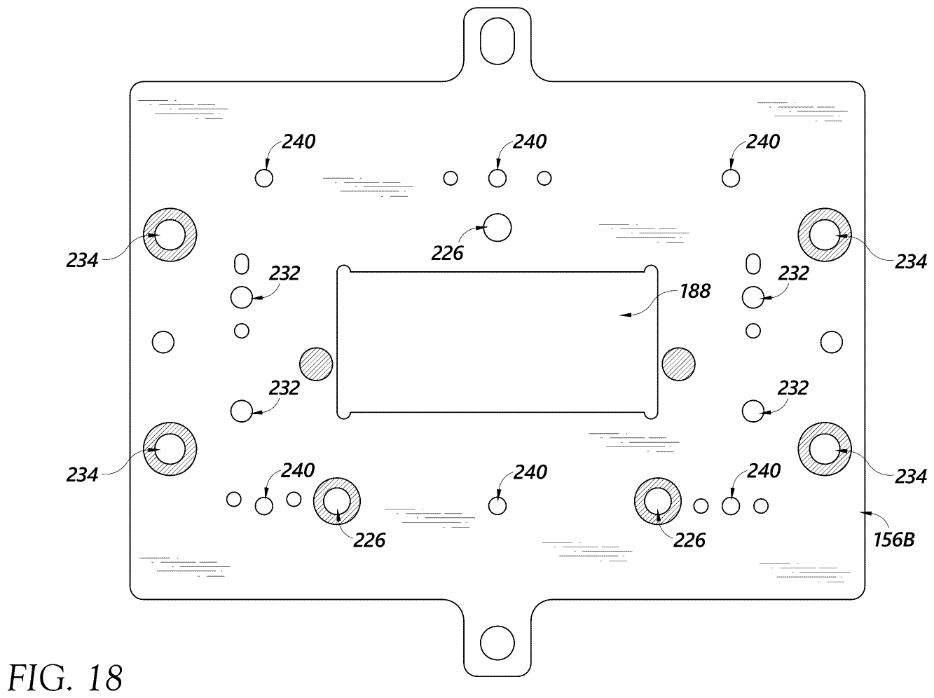

FIGS. 15 and 16 show upper and lower surfaces of the tilt member 158, respectively. In various embodiments, the upper surface of the tilt member 158 shown in FIG. 15 faces (i.e., is opposite to) the lower surface of the lower linear motion member 156B shown in FIG. 18. In various embodiments, the lower surface of the tilt member 158 shown in FIG. 16 faces (is opposite to) the sample support member 140. In various embodiments, the tilt member 158 includes an aperture 204 extending therethrough as shown in FIGS. 14-16. In various embodiments, the upper surface of the tilt member 158 shown in FIG. 15 includes the slot 208 and the recession 212 formed thereon, each of which is configured to receive a ball as shown in FIG. 14 (e.g., ball 206 in slot 208 and ball 210 within recession 212). In various embodiments, the slot 208 includes a V-shaped cross section. In various embodiments, the slot 208 includes a U-shaped cross section. In various embodiments, the slot 208 includes a trapezoidal shaped cross section.

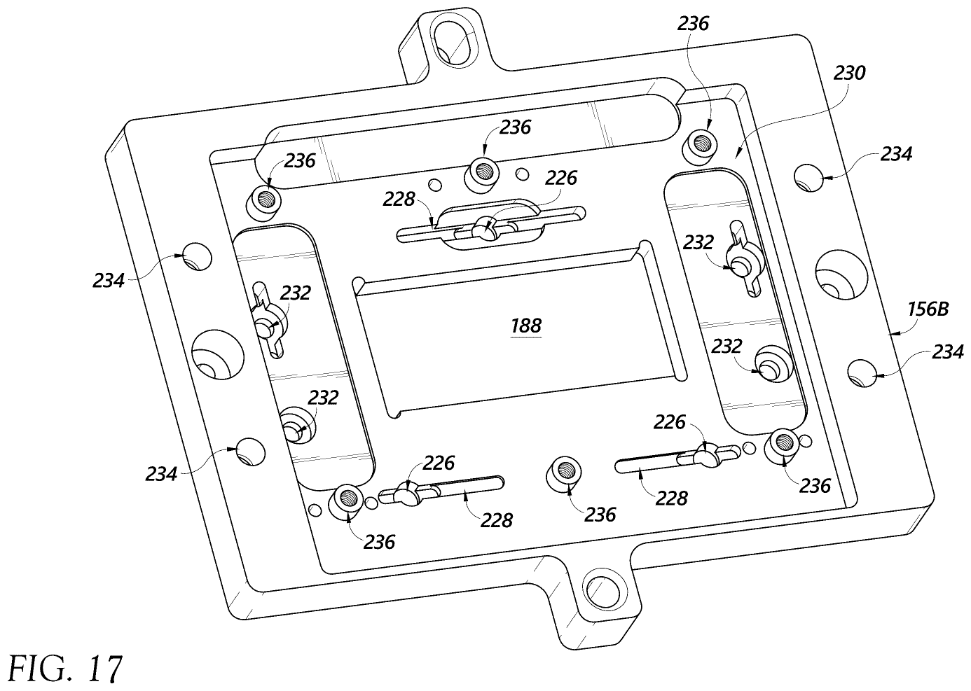

In various embodiments, the tilt member 158 includes a plurality of through-holes. In various embodiments, the tension springs 176 couple the tilt member 158 to the lower linear motion member 156B. In various embodiments, the tension springs 176 are secured to any suitable surface, e.g., the lower surface or the upper surface, of the tilt member 158. For example, the tension spring may be coupled via a pin that is passed through a first terminal end of the tension springs 176 and is positioned within the grooves 220 provided on the bottom surface of the tilt member as shown in FIG. 16. In various embodiments, the second terminal end of the tension springs 176 is received through holes 226 of the lower linear motion member 156B shown in FIG. 17 and is secured to the lower linear motion member 156B via a pin passed through the second terminal end of the tension springs 176 that is secured within grooves 228. In various embodiments, the tilt member 158 is coupled to the sample support members 140 via bolts 224 shown in FIG. 14, which extend through the holes 216 and slots 218 configured on the tilt member 158 as shown in FIGS. 15 and 16.

In various embodiments, the tilt member 158 includes one or more protrusions 222 extending from the upper surface, as shown in FIG. 15. In various embodiments, the protrusions 222 are configured with a predetermined height to limit rotational and/or pivotal displacement of the tilt member 158 relative to the lower linear motion member 156B along axis A.

FIGS. 17 and 18 show upper and lower surfaces of the lower linear motion member 156B, respectively. In various embodiments, as shown in FIG. 17, the upper surface of the lower linear motion member 156B faces (is opposite to) the upper linear motion member 156A and the lower surface of the lower linear motion member 156B shown in FIG. 18 faces (is opposite to) the upper surface of the tilt member 158 shown in FIG. 15. In various embodiments, the upper surface of the lower linear motion member 156B shown in FIG. 17 includes a recess 230 formed therein. In various embodiments, the recess 230 is configured to receive the PCB 168 and the LED assembly 186 therein. In various embodiments, the recess 230 includes an aperture 188 extending through the lower linear motion member 156B. In various embodiments, the aperture 188 is substantially rectangular. In various embodiments, the aperture 188 is substantially square. In various embodiments, the aperture 188 includes semicircular cutouts at each corner.

As shown in FIGS. 17 and 18, in various embodiments, the lower linear motion member 156B includes holes 232 through which bolts 198 can pass to secure the arms 196 to the lower linear motion member 156B. In various embodiments, the lower linear motion member 156B includes holes 234 through which the bolts 170 can pass to couple the lower linear motion member 156B with the upper linear motion member 156A. In various embodiments, the lower linear motion member 156B includes receiving elements 236 as shown in FIG. 17 configured to receive bolts 238 shown in FIGS. 10 and 12 for securing the PCB 168 to the lower linear motion portion 156B as shown in FIG. 10. As shown in FIG. 18, in various embodiments, the lower linear motion member 156B includes through holes 240 in which the receiving elements 236 can be located and secured to the lower linear motion member 156B.

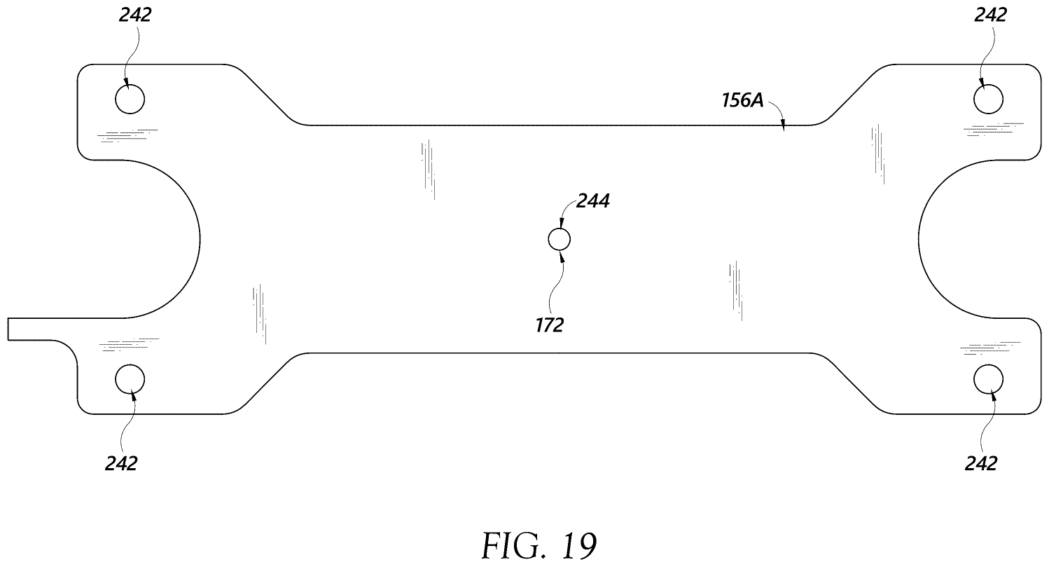

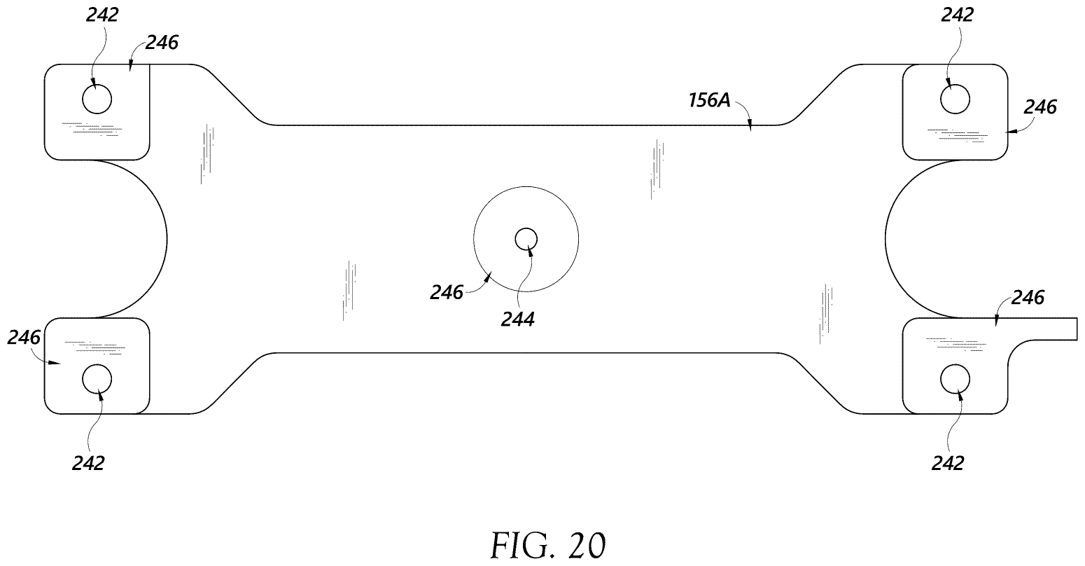

Upper and lower surfaces of the upper linear motion member 156A are shown in FIGS. 19 and 20, respectively. As shown in FIGS. 19 and 20, in various embodiments, the upper linear motion member 156 includes an elongate shape with protruding portions at each corner, although other suitable shapes would be understood by one skilled in the art. In various embodiments, holes 242 are provided through the upper linear motion member 156A to receive bolts 170 therein. In various embodiments, a first hole 244 is centrally formed within the upper linear motion member 156A and includes the receiving element 172 therein to receive the coupling means 154 therein to couple the upper linear motion member 156A to the linear actuator 152. As shown in FIG. 20, in various embodiments, the lower surface of the upper linear motion member 156A includes protruding regions 246 extending away from the lower surface so as to raise the upper linear motion member 156A away from the PCB 168 to provide space for air flow over the PCB 168.

### Spatial Analysis Methodologies

Spatial analysis methodologies described herein can provide a vast amount of analyte and/or expression data for a variety of analytes within a biological sample at high spatial resolution, while retaining native spatial context. Spatial analysis methods can include, e.g., the use of a capture probe including a spatial barcode (e.g., a nucleic acid sequence that provides information as to the location or position of an analyte within a cell or a tissue sample (e.g., mammalian cell or a mammalian tissue sample) and a capture domain that is capable of binding to an analyte (e.g., a protein and/or a nucleic acid) produced by and/or present in a cell. Spatial analysis methods and compositions can also include the use of a capture probe having a capture domain that captures an intermediate agent for indirect detection of an analyte. For example, the intermediate agent can include a nucleic acid sequence (e.g., a barcode) associated with the intermediate agent. Detection of the intermediate agent is therefore indicative of the analyte in the cell or tissue sample.

Non-limiting aspects of spatial analysis methodologies and compositions are described in U.S. Pat. Nos. 11,447,807, 11,352,667, 11,168,350, 11,104,936, 11,008,608, 10,995,361, 10,913,975, 10,774,374, 10,724,078, 10,640,816, 10,494,662, 10,480,022, 10,364,457, 10,317,321, 10,059,990, 10,041,949, 10,030,261, 10,002,316, 9,879,313, 9,783,841, 9,727,810, 9,593,365, 8,951,726, 8,604,182, and 7,709,198; U.S. Patent Application Publication Nos. 2020/0239946, 2020/0080136, 2020/0277663, 2019/0330617, 2020/0256867, 2020/0224244, 2019/0085383, and 2013/0171621; PCT Publication Nos. WO2018/091676, WO2020/176788, WO2017/144338, and WO2016/057552; Non-patent literature references Rodriques et al., Science 363(6434):1463-1467, 2019; Lee et al., Nat. Protoc. 10(3):442-458, 2015; Trejo et al., PLoS ONE 14(2):e0212031, 2019; Chen et al., Science 348(6233):aaa6090, 2015; Gao et al., BMC Biol. 15:50, 2017; and Gupta et al., Nature Biotechnol. 36:1197-1202, 2018; the Visium Spatial Gene Expression Reagent Kits User Guide (e.g., Rev F, dated January 2022); and/or the Visium Spatial Gene Expression Reagent Kits—Tissue Optimization User Guide (e.g., Rev E, dated February 2022), both of which are available at the 10× Genomics Support Documentation website, and can be used herein in any combination, and each of which is incorporated herein by reference in their entireties. Further non-limiting aspects of spatial analysis methodologies and compositions are described herein.

Some general terminology that may be used in this disclosure can be found in Section (I)(b) of PCT Publication No. WO2020/176788 and/or U.S. Patent Application Publication No. 2020/0277663. Typically, a “barcode” is a label, or identifier, which conveys or is capable of conveying information (e.g., information about an analyte in a sample, a bead, and/or a capture probe). A barcode can be part of an analyte, or independent of an analyte. A barcode can be attached to an analyte. A particular barcode can be unique relative to other barcodes. For the purpose of this disclosure, an “analyte” can include any biological substance, structure, moiety, or component to be analyzed. The term “target” can similarly refer to an analyte of interest.

Analytes can be broadly classified into one of two groups: nucleic acid analytes, and non-nucleic acid analytes. Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral proteins (e.g., viral capsid, viral envelope, viral coat, viral accessory, viral glycoproteins, viral spike, etc.), extracellular and intracellular proteins, antibodies, and antigen binding fragments. In some embodiments, the analyte(s) can be localized to subcellular location(s), including, for example, organelles, e.g., mitochondria, Golgi apparatus, endoplasmic reticulum, chloroplasts, endocytic vesicles, exocytic vesicles, vacuoles, lysosomes, etc. In some embodiments, analyte(s) can be peptides or proteins, including without limitation antibodies and enzymes. Additional examples of analytes can be found in Section (I)(c) of PCT Publication No. WO2020/176788 and/or U.S. Patent Application Publication No. 2020/0277663. In some embodiments, an analyte can be detected indirectly, such as through detection of an intermediate agent, for example, a ligation product or an analyte capture agent (e.g., an oligonucleotide-conjugated antibody), such as those described herein.

A “biological sample” is typically obtained from the subject for analysis using any of a variety of techniques including, but not limited to, biopsy, surgery, and laser capture microscopy (LCM), and generally includes cells and/or other biological material from the subject. In some embodiments, the biological sample is a tissue sample. In some embodiments, the biological sample (e.g., tissue sample) is a tissue microarray (TMA). A tissue microarray contains multiple representative tissue samples—which can be from different tissues or organisms—assembled on a single histologic slide. The TMA can therefore allow for high throughput analysis of multiple specimens at the same time. Tissue microarrays are paraffin blocks produced by extracting cylindrical tissue cores from different paraffin donor blocks and re-embedding these into a single recipient (microarray) block at defined array coordinates.

The biological sample as used herein can be any suitable biological sample described herein or known in the art. In some embodiments, the biological sample is a tissue sample. In some embodiments, the tissue sample is a solid tissue sample. In some embodiments, the biological sample is a tissue section (e.g., a fixed tissue section). In some embodiments, the tissue is flash-frozen and sectioned. Any suitable method described herein or known in the art can be used to flash-freeze and section the tissue sample. In some embodiments, the biological sample, e.g., the tissue, is flash-frozen using liquid nitrogen before sectioning. In some embodiments, the biological sample, e.g., a tissue sample, is flash-frozen using nitrogen (e.g., liquid nitrogen), isopentane, or hexane.

In some embodiments, the biological sample, e.g., the tissue, is embedded in a matrix e.g., optimal cutting temperature (OCT) compound to facilitate sectioning. OCT compound is a formulation of clear, water-soluble glycols and resins, providing a solid matrix to encapsulate biological (e.g., tissue) specimens. In some embodiments, the sectioning is performed by cryosectioning, for example using a microtome. In some embodiments, the methods further comprise a thawing step, after the cryosectioning.

The biological sample can be from a mammal. In some instances, the biological sample is from a human, mouse, or rat. In addition to the subjects described above, the biological sample can be obtained from non-mammalian organisms (e.g., a plants, an insect, an arachnid, a nematode (e.g., Caenorhabditis elegans), a fungi, an amphibian, or a fish (e.g., zebrafish)). A biological sample can be obtained from a prokaryote such as a bacterium, e.g., Escherichia coli, Staphylococci or Mycoplasma pneumoniae; an archaea; a virus such as Hepatitis C virus or human immunodeficiency virus; or a viroid. A biological sample can be obtained from a eukaryote, such as a patient derived organoid (PDO) or patient derived xenograft (PDX). The biological sample can include organoids, a miniaturized and simplified version of an organ produced in vitro in three dimensions that shows realistic micro-anatomy. Organoids can be generated from one or more cells from a tissue, embryonic stem cells, and/or induced pluripotent stem cells, which can self-organize in three-dimensional culture owing to their self-renewal and differentiation capacities. In some embodiments, an organoid is a cerebral organoid, an intestinal organoid, a stomach organoid, a lingual organoid, a thyroid organoid, a thymic organoid, a testicular organoid, a hepatic organoid, a pancreatic organoid, an epithelial organoid, a lung organoid, a kidney organoid, a gastruloid, a cardiac organoid, or a retinal organoid. Subjects from which biological samples can be obtained can be healthy or asymptomatic individuals, individuals that have or are suspected of having a disease (e.g., cancer) or a pre-disposition to a disease, and/or individuals that need therapy or are suspected of needing therapy.

Biological samples can be derived from a homogeneous culture or population of the subjects or organisms mentioned herein or alternatively from a collection of several different organisms, for example, in a community or ecosystem.

Biological samples can include one or more diseased cells. A diseased cell can have altered metabolic properties, gene expression, protein expression, and/or morphologic features. Examples of diseases include inflammatory disorders, metabolic disorders, nervous system disorders, and cancer. Cancer cells can be derived from solid tumors, hematological malignancies, cell lines, or obtained as circulating tumor cells.

In some embodiments, the biological sample, e.g., the tissue sample, is fixed in a fixative including alcohol, for example methanol. In some embodiments, instead of methanol, acetone, or an acetone-methanol mixture can be used. In some embodiments, the fixation is performed after sectioning. In some instances, when the biological sample is fixed with a fixative including an alcohol (e.g., methanol or acetone-methanol mixture), it is not decrosslinked afterward. In some preferred embodiments, the biological sample is fixed with a fixative including an alcohol (e.g., methanol or an acetone-methanol mixture) after freezing and/or sectioning. In some instances, the biological sample is flash-frozen, and then the biological sample is sectioned and fixed (e.g., using methanol, acetone, or an acetone-methanol mixture). In some instances when methanol, acetone, or an acetone-methanol mixture is used to fix the biological sample, the sample is not decrosslinked at a later step. In instances when the biological sample is frozen (e.g., flash frozen using liquid nitrogen and embedded in OCT) followed by sectioning and alcohol (e.g., methanol, acetone-methanol) fixation or acetone fixation, the biological sample is referred to as “fresh frozen”. In some embodiments, fixation of the biological sample e.g., using acetone and/or alcohol (e.g., methanol, acetone-methanol) is performed while the sample is mounted on a substrate (e.g., glass slide, such as a positively charged glass slide).

In some embodiments, the biological sample, e.g., the tissue sample, is fixed e.g., immediately after being harvested from a subject. In such embodiments, the fixative is preferably an aldehyde fixative, such as paraformaldehyde (PFA) or formalin. In some embodiments, the fixative induces crosslinks within the biological sample. In some embodiments, after fixing e.g., by formalin or PFA, the biological sample is dehydrated via sucrose gradient. In some instances, the fixed biological sample is treated with a sucrose gradient and then embedded in a matrix e.g., OCT compound. In some instances, the fixed biological sample is not treated with a sucrose gradient, but rather is embedded in a matrix e.g., OCT compound after fixation. In some embodiments when a fixed frozen tissue sample is treated with a sucrose gradient, it can be rehydrated with an ethanol gradient. In some embodiments, the PFA or formalin fixed biological sample, which can be optionally dehydrated via sucrose gradient and/or embedded in OCT compound, is then frozen e.g., for storage or shipment. In such instances, the biological sample is referred to as “fixed frozen”. In preferred embodiments, a fixed frozen biological sample is not treated with methanol. In preferred embodiments, a fixed frozen biological sample is not paraffin embedded. Thus, in preferred embodiments, a fixed frozen biological sample is not deparaffinized. In some embodiments, a fixed frozen biological sample is rehydrated in an ethanol gradient.

In some instances, the biological sample (e.g., a fixed frozen tissue sample) is treated with a citrate buffer. Citrate buffer can be used for antigen retrieval to decrosslink antigens and fixation medium in the biological sample. Thus, any suitable decrosslinking agent can be used in addition to or alternatively to citrate buffer. In some embodiments, for example, the biological sample (e.g., a fixed frozen tissue sample) is decrosslinked with TE buffer.

In any of the foregoing, the biological sample can further be stained, imaged, and/or destained. For example, in some embodiments, a fresh frozen tissue sample or fixed frozen tissue sample is stained (e.g., via eosin and/or hematoxylin), imaged, destained (e.g., via HCl), or a combination thereof. In some embodiments, when a fresh frozen tissue sample is fixed in methanol, it is treated with isopropanol prior to being stained (e.g., via eosin and/or hematoxylin), imaged, destained (e.g., via HCl), or a combination thereof. In some embodiments when a fixed frozen tissue sample is treated with a sucrose gradient, it can be rehydrated with an ethanol gradient before being stained, (e.g., via eosin and/or hematoxylin), imaged, destained (e.g., via HCl), decrosslinked (e.g., via TE buffer or citrate buffer), or a combination thereof. In some embodiments, the biological sample can undergo further fixation (e.g., while mounted on a substrate), stained, imaged, and/or destained. For example, a fixed frozen biological sample may be subject to an additional fixing step (e.g., using PFA) before optional ethanol rehydration, staining, imaging, and/or destaining.

In any of the foregoing, the biological sample can be fixed using PAXgene. For example, the biological sample can be fixed using PAXgene in addition, or alternatively to, a fixative disclosed herein or known in the art (e.g., alcohol, acetone, acetone-alcohol, formalin, paraformaldehyde). PAXgene is a non-cross-linking mixture of different alcohols, acid and a soluble organic compound that preserves morphology and bio-molecules. It is a two-reagent fixative system in which tissue is firstly fixed in a solution containing methanol and acetic acid then stabilized in a solution containing ethanol. See, Ergin B. et al., J Proteome Res. 2010 Oct. 1; 9(10):5188-96; Kap M. et al., PLoS One.; 6(11):e27704 (2011); and Mathieson W. et al., Am J Clin Pathol.; 146(1):25-40 (2016), each of which are hereby incorporated by reference in their entirety, for a description and evaluation of PAXgene for tissue fixation. Thus, in some embodiments, when the biological sample, e.g., the tissue sample, is fixed in a fixative including alcohol, the fixative is PAXgene. In some embodiments, a fresh frozen tissue sample is fixed with PAXgene. In some embodiments, a fixed frozen tissue sample is fixed with PAXgene.

In some embodiments, the biological sample, e.g., the tissue sample is fixed, for example in methanol, acetone, acetone-methanol, PFA, PAXgene or is formalin-fixed and paraffin-embedded (FFPE). In some embodiments, the biological sample comprises intact cells. In some embodiments, the biological sample is a cell pellet, e.g., a fixed cell pellet, e.g., an FFPE cell pellet. FFPE samples are used in some instances in the RTL methods disclosed herein. A limitation of direct RNA capture for fixed samples is that the RNA integrity of fixed (e.g., FFPE) samples can be lower than a fresh sample, thereby making it more difficult to capture RNA directly, e.g., by capture of a common sequence such as a poly(A) tail of an mRNA molecule. However, by utilizing RTL probes that hybridize to RNA target sequences in the transcriptome, one can avoid a requirement for RNA analytes to have both a poly(A) tail and target sequences intact. Accordingly, RTL probes can be utilized to beneficially improve capture and spatial analysis of fixed samples. The biological sample, e.g., tissue sample, can be stained, and imaged prior, during, and/or after each step of the methods described herein. Any of the methods described herein or known in the art can be used to stain and/or image the biological sample. In some embodiments, the imaging occurs prior to destaining the sample. In some embodiments, the biological sample is stained using an H&E staining method. In some embodiments, the tissue sample is stained and imaged for about 10 minutes to about 2 hours (or any of the subranges of this range described herein). Additional time may be needed for staining and imaging of different types of biological samples.

The tissue sample can be obtained from any suitable location in a tissue or organ of a subject, e.g., a human subject. In some instances, the sample is a mouse sample. In some instances, the sample is a human sample. In some embodiments, the sample can be derived from skin, brain, breast, lung, liver, kidney, prostate, tonsil, thymus, testes, bone, lymph node, ovary, eye, heart, or spleen. In some instances, the sample is a human or mouse breast tissue sample. In some instances, the sample is a human or mouse brain tissue sample. In some instances, the sample is a human or mouse lung tissue sample. In some instances, the sample is a human or mouse tonsil tissue sample. In some instances, the sample is a human or mouse liver tissue sample. In some instances, the sample is a human or mouse bone, skin, kidney, thymus, testes, or prostate tissue sample. In some embodiments, the tissue sample is derived from normal or diseased tissue. In some embodiments, the sample is an embryo sample. The embryo sample can be a non-human embryo sample. In some instances, the sample is a mouse embryo sample.

Biological samples are also described in Section (I)(d) of PCT Publication No. WO2020/176788 and/or U.S. Patent Application Publication No. 2020/0277663.

The following embodiments can be used with any of the methods described herein. In some embodiments, the biological sample (e.g., a fixed and/or stained biological sample) is imaged. In some embodiments, the biological sample is visualized or imaged using bright field microscopy. In some embodiments, the biological sample is visualized or imaged using fluorescence microscopy. Additional methods of visualization and imaging are known in the art. Non-limiting examples of visualization and imaging include expansion microscopy, bright field microscopy, dark field microscopy, phase contrast microscopy, electron microscopy, fluorescence microscopy, reflection microscopy, interference microscopy and confocal microscopy. In some embodiments, the sample is stained and imaged prior to adding reagents for analyzing captured analytes as disclosed herein to the biological sample.

In some embodiments, the methods include staining the biological sample. In some embodiments, the staining includes the use of hematoxylin and/or eosin. Non-limiting examples of stains include histological stains (e.g., hematoxylin and/or eosin) and immunological stains (e.g., fluorescent stains). In some embodiments, a biological sample can be stained using any number of biological stains, including but not limited to, acridine orange, Bismarck brown, carmine, coomassie blue, cresyl violet, DAPI, eosin, ethidium bromide, acid fuchsine, hematoxylin, Hoechst stains, iodine, methyl green, methylene blue, neutral red, Nile blue, Nile red, osmium tetroxide, propidium iodide, rhodamine, or safranin. In some instances, the biological sample can be stained using known staining techniques, including Can-Grunwald, Giemsa, hematoxylin and eosin (H&E), Jenner's, Leishman, Masson's trichrome, Papanicolaou, Romanowsky, silver, Sudan, Wright's, and/or Periodic Acid Schiff (PAS) staining techniques. PAS staining is typically performed after formalin or acetone fixation.

In some embodiments, the staining includes the use of a detectable label selected from the group consisting of a radioisotope, a fluorophore, a chemiluminescent compound, a bioluminescent compound, or a combination thereof.

In some embodiments, a biological sample is permeabilized with one or more permeabilization reagents. For example, permeabilization of a biological sample can facilitate analyte capture. Exemplary permeabilization agents and conditions are described in Section (I)(d)(ii)(13) or the Exemplary Embodiments Section of PCT Publication No. WO2020/176788 and/or U.S. Patent Application Publication No. 2020/0277663. Briefly, in any of the methods described herein, the method includes a step of permeabilizing the biological sample. For example, the biological sample can be permeabilized to facilitate transfer of the extension products to the capture probes on the array. In some embodiments, the permeabilizing includes the use of an organic solvent (e.g., acetone, ethanol, and methanol), a detergent (e.g., saponin, Triton X-100™, Tween-20™, or sodium dodecyl sulfate (SDS)), an enzyme (an endopeptidase, an exopeptidase, a protease), or combinations thereof. In some embodiments, the permeabilizing includes the use of an endopeptidase, a protease, SDS, polyethylene glycol tert-octylphenyl ether, polysorbate 80, and polysorbate 20, N-lauroylsarcosine sodium salt solution, saponin, Triton X-100™, Tween-20™, or combinations thereof. In some embodiments, the endopeptidase is pepsin. In some embodiments, the endopeptidase is Proteinase K. Additional methods for sample permeabilization are described, for example, in Jamur et al., Method Mol. Biol. 588:63-66, 2010, the entire contents of which are incorporated herein by reference.

Array-based spatial analysis methods can involve the transfer of one or more analytes or derivatives thereof from a biological sample to an array of features on a substrate, where each feature is associated with a unique spatial location on the array. Subsequent analysis of the transferred analytes includes determining the identity of the analytes and the spatial location of the analytes within the biological sample. The spatial location of an analyte within the biological sample is determined based on the feature to which the analyte is bound (e.g., directly or indirectly) on the array, and the feature's relative spatial location within the array.

A “capture probe” refers to any molecule capable of capturing (directly or indirectly) and/or labelling an analyte (e.g., an analyte of interest) in a biological sample. In some embodiments, the capture probe is a nucleic acid or a polypeptide. In some embodiments, the capture probe includes a barcode (e.g., a spatial barcode and/or a unique molecular identifier (UMI) and a capture domain). In some instances, the capture probe includes a homopolymer sequence, such as a poly(T) sequence. In some embodiments, a capture probe can include a cleavage domain and/or a functional domain (e.g., a primer-binding site, such as for next-generation sequencing (NGS)). See, e.g., Section (II)(b) (e.g., subsections (i)-(vi)) of PCT Publication No. WO2020/176788 and/or U.S. Patent Application Publication No. 2020/0277663. Generation of capture probes can be achieved by any appropriate method, including those described in Section (II)(d)(ii) of PCT Publication No. WO2020/176788 and/or U.S. Patent Application Publication No. 2020/0277663.

In some instances, a capture probe and a nucleic acid analyte (or any other nucleic acid to nucleic acid interaction) occurs because the sequences of the two nucleic acids are substantially complementary to one another. By “substantial,” “substantially” and the like, two nucleic acid sequences can be complementary when at least 60% of the nucleotide residues of one nucleic acid sequence are complementary to nucleotide residues in the other nucleic acid sequence. The complementary residues within a particular complementary nucleic acid sequence need not always be contiguous with each other, and can be interrupted by one or more non-complementary residues within the complementary nucleic acid sequence. In some embodiments, at least 60%, but less than 100%, of the residues of one of the two complementary nucleic acid sequences are complementary to residues in the other nucleic acid sequence. In some embodiments, at least 70%, 80%, 90%, 95% or 99% of the residues of one nucleic acid sequence are complementary to residues in the other nucleic acid sequence. Sequences are said to be “substantially complementary” when at least 60% (e.g., at least 70%, at least 80%, or at least 90%) of the residues of one nucleic acid sequence are complementary to residues in the other nucleic acid sequence. In some embodiments, the biological sample is mounted on a first substrate and the substrate comprising the array of capture probes is a second substrate. During this process, one or more analytes or analyte derivatives (e.g., intermediate agents; e.g., ligation products) are released from the biological sample and migrate to the second substrate comprising an array of capture probes. In some embodiments, the release and migration of the analytes or analyte derivatives to the second substrate comprising the array of capture probes occurs in a manner that preserves the original spatial context of the analytes in the biological sample. This method can be referred to as a sandwiching process, which is described e.g., in U.S. Patent Application Pub. No. 2021/0189475 and PCT Pub. Nos. WO 2021/252747 A1, WO 2022/061152 A2, and WO 2022/140028 A1.

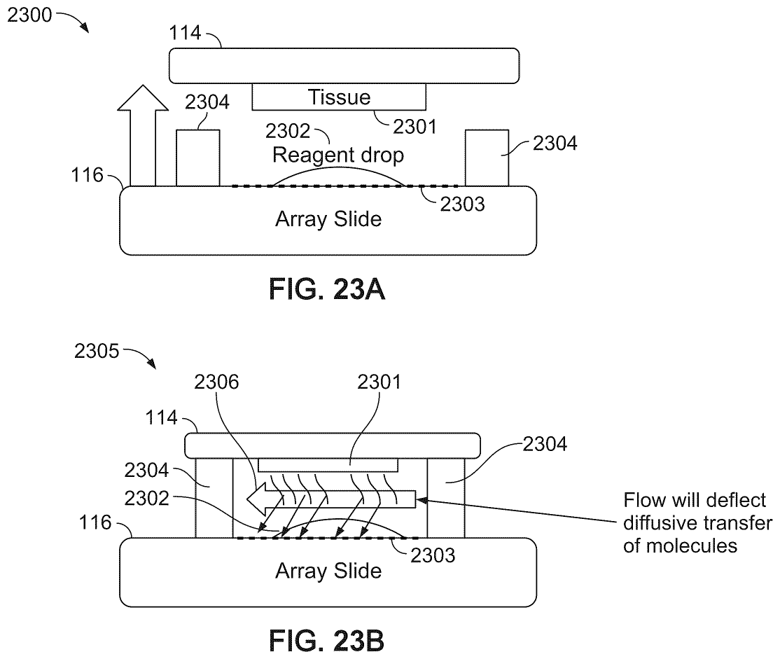

FIGS. 23A and 23B shows an exemplary sandwiching process 23000 where a first substrate (e.g., slide 114), including a biological sample 2101, and a second substrate (e.g., array slide 116 including an array 2303 having spatially barcoded capture probes) are brought into proximity with one another. As shown in FIG. 23A a liquid reagent drop (e.g., permeabilization solution 2302) is introduced on the second substrate in proximity to the capture probes of the array 2303 and in between the biological sample 2301 and the second substrate (e.g., slide 116 including an array having spatially barcoded capture probes 2303). The permeabilization solution 2302 may release analytes or analyte derivatives (e.g., intermediate agents; e.g., ligation products) that can be captured by the capture probes of the array 2303.

During the exemplary sandwiching process, the first substrate is aligned with the second substrate, such that at least a portion of the biological sample is aligned with at least a portion of the capture probes (e.g., aligned in a sandwich configuration). As shown, the second substrate (e.g., array slide 116) is in an inferior position to the first substrate (e.g., slide 114). In some embodiments, the first substrate (e.g., slide 114) may be positioned superior to the second substrate (e.g., slide 116). A reagent medium 2302 within a gap between the first substrate (e.g., slide 114) and the second substrate (e.g., slide 116) creates a liquid interface between the two substrates. The reagent medium may be a permeabilization solution which permeabilizes and/or digests the biological sample 2301. In some embodiments wherein the biological sample 2301 has been pre-permeabilized, the reagent medium is not a permeabilization solution. Herein, the reagent medium may also comprise one or more of a monovalent salt, a divalent salt, ethylene carbonate, and/or glycerol. In some embodiments, analytes (e.g., mRNA transcripts) and/or analyte derivatives (e.g., intermediate agents; e.g., ligation products) of the biological sample 2301 may release from the biological sample, and actively or passively migrate (e.g., diffuse) across the gap toward the capture probes on the array 2303. Alternatively, in certain embodiments, migration of the analyte or analyte derivative (e.g., intermediate agent; e.g., ligation product) from the biological sample is performed actively (e.g., electrophoretic, by applying an electric field to promote migration). Exemplary methods of electrophoretic migration are described in WO 2020/176788, and US. Patent Application Pub. No. 2021/0189475, each of which is hereby incorporated by reference.

As further shown, one or more spacers 2304 may be positioned between the first substrate (e.g., slide 114) and the second substrate (e.g., array slide 116 including the array 2303 of spatially barcoded capture probes). The one or more spacers 2304 may be configured to maintain a separation distance between the first substrate and the second substrate. While the one or more spacers 2304 is shown as disposed on the second substrate, the spacer may additionally or alternatively be disposed on the first substrate.

In some embodiments, the one or more spacers 2304 is configured to maintain a separation distance between first and second substrates that is between about 2 microns and 1 mm (e.g., between about 2 microns and 800 microns, between about 2 microns and 700 microns, between about 2 microns and 600 microns, between about 2 microns and 500 microns, between about 2 microns and 400 microns, between about 2 microns and 300 microns, between about 2 microns and 200 microns, between about 2 microns and 100 microns, between about 2 microns and 25 microns, or between about 2 microns and 10 microns), measured in a direction orthogonal to the surface of first substrate that supports the biological sample. In some instances, the separation distance is about 2, 3, 4, 5, 6, 7, 8, 9, 10, 11, 12, 13, 14, 15, 16, 17, 18, 19, 20, 21, 22, 23, 24, or 25 microns. In some embodiments, the separation distance is less than 50 microns. In some embodiments, the separation distance is less than 25 microns. In some embodiments, the separation distance is less than 20 microns. The separation distance may include a distance of at least 2 μm.

FIG. 23B shows a fully formed sandwich configuration 2305 creating a chamber 2306 formed from the one or more spacers 2304, the first substrate (e.g., the slide 114), and the second substrate (e.g., the slide 116 including an array 2303 having spatially barcoded capture probes) in accordance with some example implementations. In the example of FIG. 23B, the liquid reagent (e.g., the permeabilization solution 2302) fills the volume of the chamber 2306 and may create a permeabilization buffer that allows analytes (e.g., mRNA transcripts and/or other molecules) or analyte derivatives (e.g., intermediate agents; e.g., ligation products) to diffuse from the biological sample 2301 toward the capture probes of the second substrate (e.g., slide 116). In some aspects, flow of the permeabilization buffer may deflect transcripts and/or molecules from the biological sample 2301 and may affect diffusive transfer of analytes or analyte derivatives (e.g., intermediate agents; e.g., ligation products) for spatial analysis. A partially or fully sealed chamber 2306 resulting from the one or more spacers 2304, the first substrate, and the second substrate may reduce or prevent flow from undesirable convective movement of transcripts and/or molecules over the diffusive transfer from the biological sample 2301 to the capture probes.

The sandwiching process methods described above can be implemented using a variety of hardware components. For example, the sandwiching process methods can be implemented using a sample holder (also referred to herein as a support device, a sample handling apparatus, and an array alignment device). Further details on support devices, sample holders, sample handling apparatuses, or systems for implementing a sandwiching process are described in, e.g., US. Patent Application Pub. No. 2021/0189475, and PCT Publ. No. WO 2022/061152 A2, each of which are incorporated by reference in their entirety.

In some embodiments of a sample holder, the sample holder can include a first member including a first retaining mechanism configured to retain a first substrate comprising a biological sample. The first retaining mechanism can be configured to retain the first substrate disposed in a first plane. The sample holder can further include a second member including a second retaining mechanism configured to retain a second substrate disposed in a second plane. The sample holder can further include an alignment mechanism connected to one or both of the first member and the second member. The alignment mechanism can be configured to align the first and second members along the first plane and/or the second plane such that the sample contacts at least a portion of the reagent medium when the first and second members are aligned and within a threshold distance along an axis orthogonal to the second plane. The adjustment mechanism may be configured to move the second member along the axis orthogonal to the second plane and/or move the first member along an axis orthogonal to the first plane.

In some embodiments, the adjustment mechanism includes a linear actuator. In some embodiments, the linear actuator is configured to move the second member along an axis orthogonal to the plane of the first member and/or the second member. In some embodiments, the linear actuator is configured to move the first member along an axis orthogonal to the plane of the first member and/or the second member. In some embodiments, the linear actuator is configured to move the first member, the second member, or both the first member and the second member at a velocity of at least 0.1 mm/sec. In some embodiments, the linear actuator is configured to move the first member, the second member, or both the first member and the second member with an amount of force of at least 0.1 lbs.

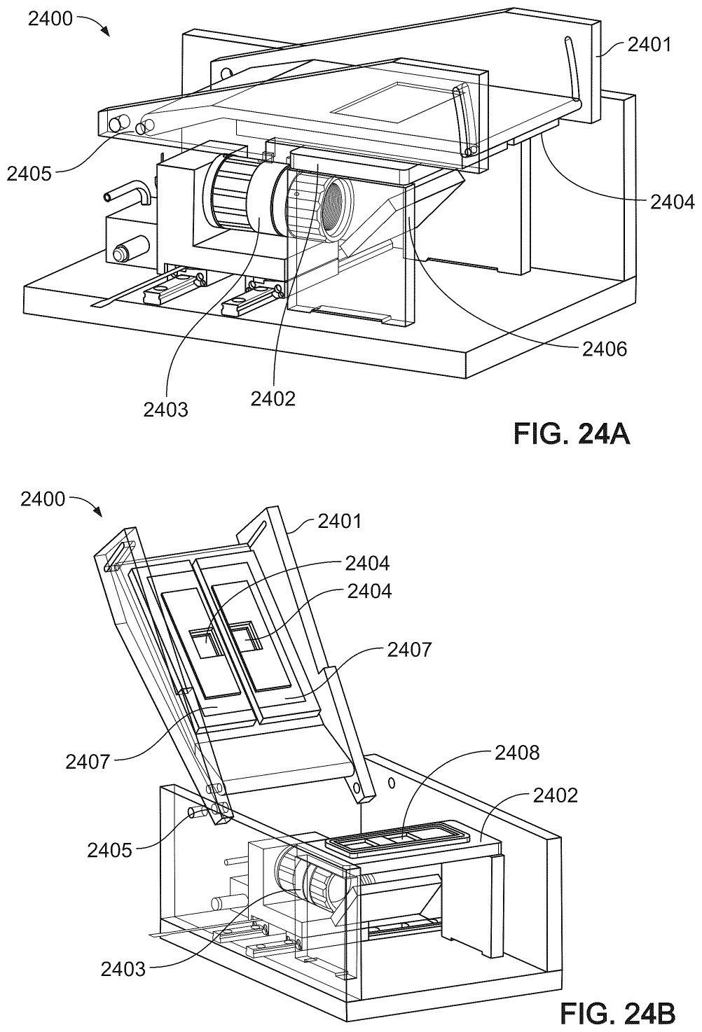

FIG. 24A is a perspective view of an example sample handling apparatus 2400 in a closed position in accordance with some example implementations. As shown, the sample handling apparatus 2400 includes a first member 2401, a second member 2402, optionally an image capture device 2403, a first substrate 2404, optionally a hinge 2405, and optionally a mirror 2406. The hinge 2405 may be configured to allow the first member 2401 to be positioned in an open or closed configuration by opening and/or closing the first member 2401 in a clamshell manner along the hinge 2405.

FIG. 24B is a perspective view of the example sample handling apparatus 2400 in an open position in accordance with some example implementations. As shown, the sample handling apparatus 2400 includes one or more first retaining mechanisms 2407 configured to retain one or more first substrates 2404. In the example of FIG. 24B, the first member 2401 is configured to retain two first substrates 2404, however the first member 2401 may be configured to retain more or fewer first substrates 2404.

In some aspects, when the sample handling apparatus 2400 is in an open position (e.g., in FIG. 24B), the first substrate 2404 and/or the second substrate 2408 may be loaded and positioned within the sample handling apparatus 2400 such as within the first member 2401 and the second member 2402, respectively. As noted, the hinge 2405 may allow the first member 2401 to close over the second member 2402 and form a sandwich configuration.

In some aspects, after the first member 2401 closes over the second member 2402, an adjustment mechanism of the sample handling apparatus 2400 may actuate the first member 2401 and/or the second member 2402 to form the sandwich configuration for the permeabilization step (e.g., bringing the first substrate 2404 and the second substrate 2408 closer to each other and within a threshold distance for the sandwich configuration). The adjustment mechanism may be configured to control a speed, an angle, a force, or the like of the sandwich configuration.

In some embodiments, the biological sample (e.g., sample 2301 from FIG. 23A) may be aligned within the first member 2401 (e.g., via the first retaining mechanism 2407) prior to closing the first member 2401 such that a desired region of interest of the sample is aligned with the barcoded array of the second substrate (e.g., the slide 116 from FIG. 23A), e.g., when the first and second substrates are aligned in the sandwich configuration. Such alignment may be accomplished manually (e.g., by a user) or automatically (e.g., via an automated alignment mechanism). After or before alignment, spacers may be applied to the first substrate 2404 and/or the second substrate 2408 to maintain a minimum spacing between the first substrate 2404 and the second substrate 2408 during sandwiching. In some aspects, the permeabilization solution (e.g., permeabilization solution 2302) may be applied to the first substrate 2404 and/or the second substrate 2408. The first member 2401 may then close over the second member 2402 and form the sandwich configuration. Analytes or analyte derivatives (e.g., intermediate agents; e.g., ligation products) may be captured by the capture probes of the array and may be processed for spatial analysis.

In some embodiments, during the permeabilization step, the image capture device 2403 may capture images of the overlap area between the biological sample and the capture probes on the array 2303. If more than one first substrates 2404 and/or second substrates 2408 are present within the sample handling apparatus 2400, the image capture device 2403 may be configured to capture one or more images of one or more overlap areas.

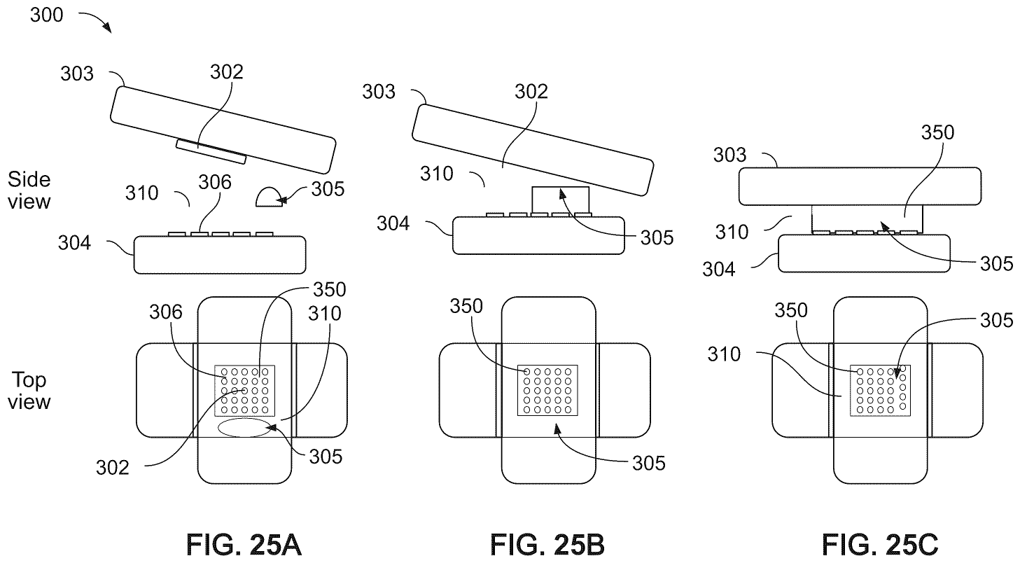

Provided herein are methods for delivering a fluid to a biological sample disposed on an area of a first substrate and an array disposed on a second substrate. FIGS. 25A-25C depict a side view and a top view of an exemplary angled closure workflow 300 for sandwiching a first substrate (e.g., slide 303) having a biological sample 302 and a second substrate (e.g., slide 304 having capture probes 306) in accordance with some exemplary implementations.

FIG. 25A depicts the first substrate (e.g., the slide 303 including a biological sample 302) angled over (superior to) the second substrate (e.g., slide 304). As shown, reagent medium (e.g., permeabilization solution) 305 is located on the spacer 310 toward the right-hand side of the side view in FIG. 25A. While FIG. 25A depicts the reagent medium on the right-side of side view, it should be understood that such depiction is not meant to be limiting as to the location of the reagent medium on the spacer.

FIG. 25B shows that as the first substrate lowers, and/or as the second substrate rises, the dropped side of the first substrate (e.g., a side of the slide 303 angled toward the second substrate) may contact the reagent medium 305. The dropped side of the first substrate may urge the reagent medium 305 toward the opposite direction (e.g., towards an opposite side of the spacer 310, towards an opposite side of the first substrate relative to the dropped side). For example, in the side view of FIG. 25B the reagent medium 305 may be urged from right to left as the sandwich is formed.

In some embodiments, the first substrate and/or the second substrate are further moved to achieve an approximately parallel arrangement of the first substrate and the second substrate.

FIG. 25C depicts a full closure of the sandwich between the first substrate and the second substrate with the spacer 310 contacting both the first substrate and the second substrate and maintaining a separation distance and optionally the approximately parallel arrangement between the two substrates. As shown in the top view of FIG. 25C, the spacer 310 fully encloses and surrounds the biological sample 302 and the capture probes 306, and the spacer 310 form the sides of chamber 350 which holds a volume of the reagent medium 305.

While FIG. 25C depicts the first substrate (e.g., the slide 303 including biological sample 302) angled over (superior to) the second substrate (e.g., slide 304) and the second substrate comprising the spacer 310, it should be understood that an exemplary angled closure workflow can include the second substrate angled over (superior to) the first substrate and the first substrate comprising the spacer 310.

It may be desirable that the reagent medium be free from air bubbles between the substrates to facilitate transfer of target analytes with spatial information. Additionally, air bubbles present between the substrates may obscure at least a portion of an image capture of a desired region of interest. Accordingly, it may be desirable to ensure or encourage suppression and/or elimination of air bubbles between the two substrates (e.g., slide 303 and slide 304) during a permeabilization step as described herein. In some aspects, it may be possible to reduce or eliminate bubble formation between the substrates using a variety of filling methods and/or closing methods. In some instances, the first substrate and the second substrate are arranged in an angled sandwich assembly as described herein. For example, during the sandwiching of the two substrates (e.g., the slide 303 and the slide 304), an angled closure workflow may be used to suppress or eliminate bubble formation.

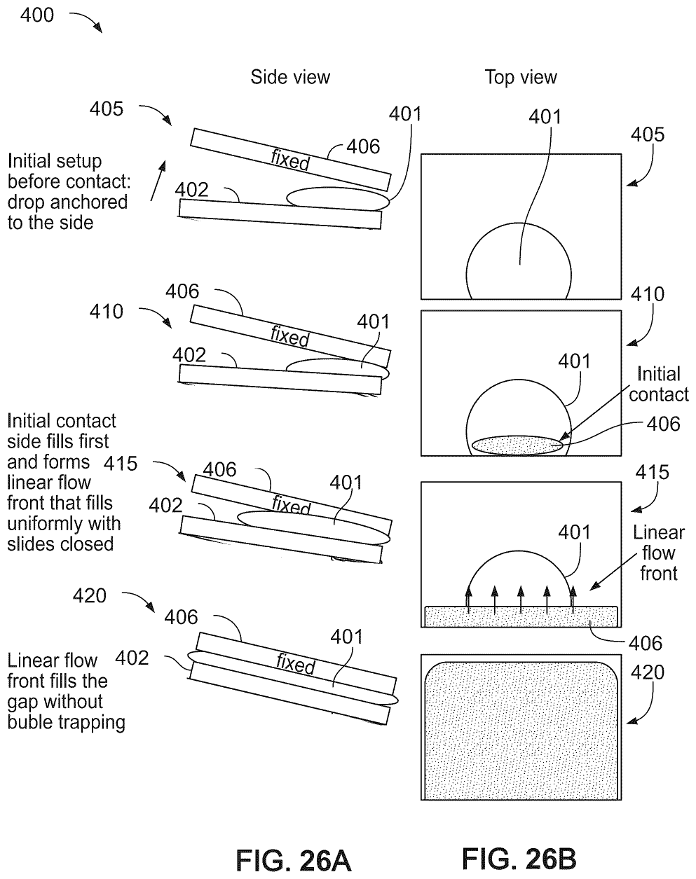

FIG. 26A is a side view of the angled closure workflow 400 in accordance with some exemplary implementations. FIG. 26B is a top view of the angled closure workflow 400 in accordance with some exemplary implementations. As shown at 405, reagent medium 401 is positioned to the side of the substrate 402 contacting the spring.

At step 410, the dropped side of the angled substrate 406 contacts the reagent medium 401 first. The contact of the substrate 406 with the reagent medium 401 may form a linear or low curvature flow front that fills uniformly with the slides closed.

At step 415, the substrate 406 is further lowered toward the substrate 402 (or the substrate 402 is raised up toward the substrate 406) and the dropped side of the substrate 406 may contact and may urge the reagent medium toward the side opposite the dropped side and creating a linear or low curvature flow front that may prevent or reduce bubble trapping between the substrates.

At step 420, the reagent medium 401 fills the gap between the substrate 406 and the substrate 402. The linear flow front of the liquid reagent may form by squeezing the 401 volume along the contact side of the substrate 402 and/or the substrate 406. Additionally, capillary flow may also contribute to filling the gap area.

In some embodiments, the reagent medium (e.g., 2302 in FIG. 23A) comprises a permeabilization agent. In some embodiments, following initial contact between the biological sample and a permeabilization agent, the permeabilization agent can be removed from contact with the biological sample (e.g., by opening the sample holder). Suitable agents for this purpose include, but are not limited to, organic solvents (e.g., acetone, ethanol, and methanol), cross-linking agents (e.g., paraformaldehyde), detergents (e.g., saponin, Triton X-100™, Tween-20™, or sodium dodecyl sulfate (SDS)), and enzymes (e.g., trypsin, proteases (e.g., proteinase K). In some embodiments, the detergent is an anionic detergent (e.g., SDS or N-lauroylsarcosine sodium salt solution).

In some embodiments, the reagent medium comprises a lysis reagent. Lysis solutions can include ionic surfactants such as, for example, sarkosyl and sodium dodecyl sulfate (SDS). More generally, chemical lysis agents can include, without limitation, organic solvents, chelating agents, detergents, surfactants, and chaotropic agents. In some embodiments, the reagent medium comprises a protease. Exemplary proteases include, e.g., pepsin, trypsin, elastase, and proteinase K. In some embodiments, the reagent medium comprises a nuclease. In some embodiments, the nuclease comprises an RNase. In some embodiments, the RNase is selected from RNase A, RNase C, RNase H, and RNase I. In some embodiments, the reagent medium comprises one or more of sodium dodecyl sulfate (SDS) or a sodium salt thereof, proteinase K, pepsin, N-lauroylsarcosine, and RNase.

In some embodiments, the reagent medium comprises polyethylene glycol (PEG). In some embodiments, the PEG is from about 2K to about 16K. In some embodiments, the PEG is 2K, 3K, 4K, 5K, 6K, 7K, 8K, 9K, 10K, 11K, 12K, 13K, 14K, 15K, or 16K. In some embodiments, the PEG is present at a concentration from about 2% to 25%, from about 4% to about 23%, from about 6% to about 21%, or from about 8% to about 20% (v/v).

In certain embodiments a dried permeabilization reagent is applied or formed as a layer on the first substrate or the second substrate or both prior to contacting the biological sample with the array. For example, a permeabilization reagent can be deposited in solution on the first substrate or the second substrate or both and then dried.

In some instances, the aligned portions of the biological sample and the array are in contact with the reagent medium for about 1 minute, about 5 minutes, about 10 minutes, about 12 minutes, about 15 minutes, about 18 minutes, about 20 minutes, about 25 minutes, about 30 minutes, about 36 minutes, about 45 minutes, or about an hour. In some instances, the aligned portions of the biological sample and the array are in contact with the reagent medium for about 1-60 minutes.

In some instances, the device is configured to control a temperature of the first and second substrates. In some embodiments, the temperature of the first and second members is lowered to a first temperature that is below room temperature.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the biological sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (II)(b)(vii) of PCT Publication No. WO2020/176788 and/or U.S. Patent Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligation products that serve as proxies for the template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended by a reverse transcriptase. In some embodiments, the capture probe is extended using one or more DNA polymerases. In some embodiments, the extended capture probes include the sequence of the capture domain, the sequence of the spatial barcode of the capture probe, and the complementary sequence of the template used for extension of the capture probe.

In some embodiments, extended capture probes are amplified (e.g., in bulk solution or on the array) to yield quantities that are sufficient for downstream analysis, e.g., sequencing. In some embodiments, extended capture probes (e.g., DNA molecules) can act as templates for an amplification reaction (e.g., a polymerase chain reaction).

Additional variants of spatial analysis methods, including in some embodiments, an imaging step, are described in Section (II)(a) of PCT Publication No. WO2020/176788 and/or U.S. Patent Application Publication No. 2020/0277663. Analysis of captured analytes (and/or intermediate agents or portions thereof), for example, including sample removal, extension of capture probes using the capture analyte as a template, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (II)(g) of PCT Publication No. WO2020/176788 and/or U.S. Patent Application Publication No. 2020/0277663. Some quality control measures are described in Section (II)(h) of PCT Publication No. WO2020/176788 and/or U.S. Patent Application Publication No. 2020/0277663.

Spatial information can provide information of medical importance. For example, the methods described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder. Exemplary methods for identifying spatial information of biological and/or medical importance can be found in U.S. Patent Application Publication Nos. 2021/0140982, 2021/0198741, and 2021/0199660.

Spatial information can provide information of biological importance. For example, the methods described herein can allow for: identification of transcriptome and/or proteome expression profiles (e.g., in healthy and/or diseased tissue); identification of multiple analyte types in close proximity (e.g., nearest neighbor or proximity based analysis); determination of up- and/or down-regulated genes and/or proteins in diseased tissue; characterization of tumor microenvironments; characterization of tumor immune responses; characterization of cells types and their co-localization in healthy and diseased tissue; and identification of genetic variants within tissues (e.g., based on gene and/or protein expression profiles associated with specific disease or disorder biomarkers).

Typically, for spatial array-based methods, a substrate functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section (II)(c) of PCT Publication No. WO2020/176788 and/or U.S. Patent Application Publication No. 2020/0277663. Exemplary features and geometric attributes of an array can be found in Sections (II)(d)(i), (II)(d)(iii), and (II)(d)(iv) of PCT Publication No. WO2020/176788 and/or U.S. Patent Application Publication No. 2020/0277663.

Generally, analytes and/or intermediate agents (or portions thereof) can be captured when contacting a biological sample with a substrate including capture probes (e.g., a substrate with capture probes embedded, spotted, printed, fabricated on the substrate, or a substrate with features (e.g., beads, wells) comprising capture probes). As used herein, “contact,” “contacted,” and/or “contacting,” a biological sample with a substrate refers to any contact (e.g., direct or indirect) such that capture probes can interact (e.g., bind covalently or non-covalently (e.g., hybridize)) with analytes from the biological sample. Capture can be achieved actively (e.g., using electrophoresis) or passively (e.g., using diffusion). Analyte capture is further described in Section (II)(e) of PCT Publication No. WO2020/176788 and/or U.S. Patent Application Publication No. 2020/0277663.

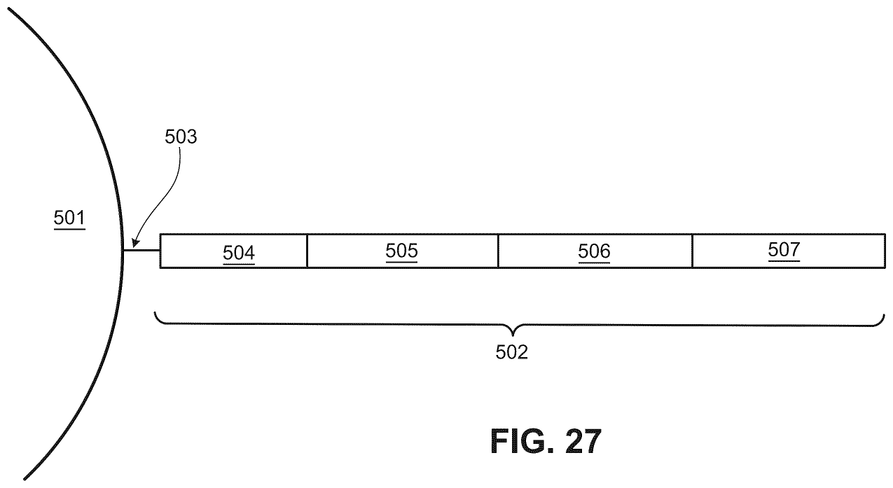

FIG. 27 is a schematic diagram showing an exemplary capture probe, as described herein. As shown, the capture probe 502 is optionally coupled to a feature 501 by a cleavage domain 503, such as a disulfide linker. The capture probe can include a functional sequence 504 that is useful for subsequent processing. The functional sequence 504 can include all or a part of sequencer specific flow cell attachment sequence (e.g., a P5 or P7 sequence), all or a part of a sequencing primer sequence, (e.g., a R1 primer binding site, a R2 primer binding site), or combinations thereof. The capture probe can also include a spatial barcode 505. The capture probe can also include a unique molecular identifier (UMI) sequence 506. While FIG. 27 shows the spatial barcode 505 as being located upstream (5′) of UMI sequence 506, it is to be understood that capture probes wherein UMI sequence 506 is located upstream (5′) of the spatial barcode 505 is also suitable for use in any of the methods described herein. The capture probe can also include a capture domain 507 to facilitate capture of a target analyte. The capture domain can have a sequence complementary to a sequence of a nucleic acid analyte. The capture domain can have a sequence complementary to a connected probe described herein. The capture domain can have a sequence complementary to an analyte capture sequence present in an analyte capture agent. The capture domain can have a sequence complementary to a splint oligonucleotide. A splint oligonucleotide, in addition to having a sequence complementary to a capture domain of a capture probe, can have a sequence complementary to a sequence of a nucleic acid analyte, a portion of a connected probe described herein, a capture handle sequence described herein, and/or a methylated adaptor described herein.

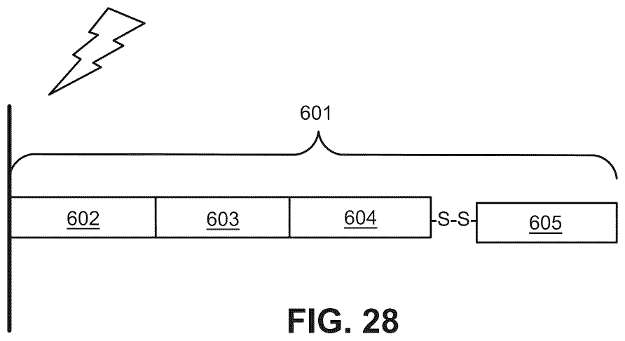

FIG. 28 is a schematic illustrating a cleavable capture probe, wherein the cleaved capture probe can enter into a non-permeabilized cell and bind to analytes within the sample. The capture probe 601 contains a cleavage domain 602, a cell penetrating peptide 603, a reporter molecule 604, and a disulfide bond (—S—S—). 605 represents all other parts of a capture probe, for example a spatial barcode and a capture domain.

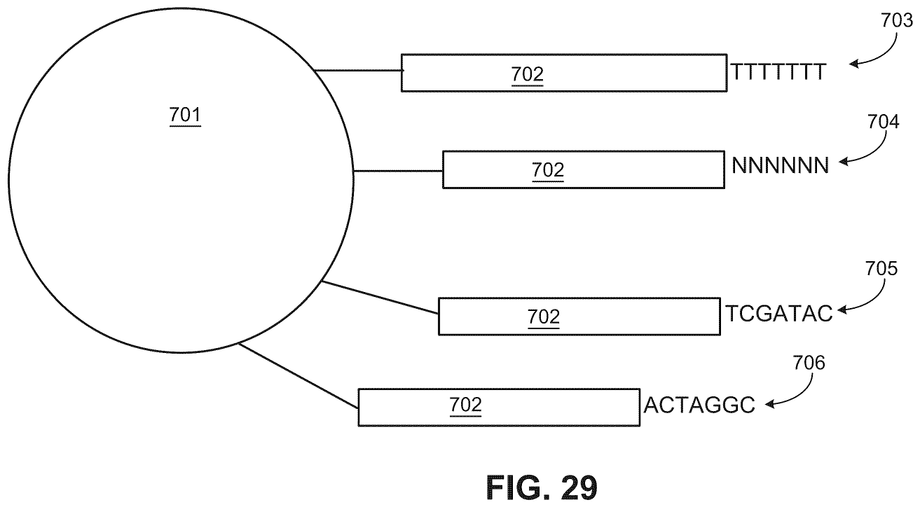

FIG. 29 is a schematic diagram of an exemplary multiplexed spatially-barcoded feature. In FIG. 29, the feature 701 can be coupled to spatially-barcoded capture probes, wherein the spatially-barcoded probes of a particular feature can possess the same spatial barcode, but have different capture domains designed to associate the spatial barcode of the feature with more than one target analyte. For example, a feature may include four different types of spatially-barcoded capture probes, each type of spatially-barcoded capture probe possessing the spatial barcode 702. One type of capture probe associated with the feature includes the spatial barcode 702 in combination with a poly(T) capture domain 703, designed to capture mRNA target analytes. A second type of capture probe associated with the feature includes the spatial barcode 702 in combination with a random N-mer capture domain 704 for gDNA analysis. A third type of capture probe associated with the feature includes the spatial barcode 702 in combination with a capture domain complementary to the analyte capture agent of interest 705. A fourth type of capture probe associated with the feature includes the spatial barcode 702 in combination with a capture probe that can specifically bind a nucleic acid molecule 706 that can function in a CRISPR assay (e.g., CRISPR/Cas9). While only four different capture probe-barcoded constructs are shown in FIG. 29, capture-probe barcoded constructs can be tailored for analyses of any given analyte associated with a nucleic acid and capable of binding with such a construct. For example, the schemes shown in FIG. 7 can also be used for concurrent analysis of other analytes disclosed herein, including, but not limited to: (a) mRNA, a lineage tracing construct, cell surface or intracellular proteins and metabolites, and gDNA; (b) mRNA, accessible chromatin (e.g., ATAC-seq, DNase-seq, and/or MNase-seq) cell surface or intracellular proteins and metabolites, and a perturbation agent (e.g., a CRISPR crRNA/sgRNA, TALEN, zinc finger nuclease, and/or antisense oligonucleotide as described herein); (c) mRNA, cell surface or intracellular proteins and/or metabolites, a barcoded labelling agent (e.g., the MHC multimers described herein), and a V(D)J sequence of an immune cell receptor (e.g., T-cell receptor). In some embodiments, a perturbation agent can be a small molecule, an antibody, a drug, an aptamer, a miRNA, a physical environmental (e.g., temperature change), or any other known perturbation agents.

The functional sequences can generally be selected for compatibility with any of a variety of different sequencing systems, e.g., Ion Torrent Proton or PGM, Illumina sequencing instruments, PacBio, Oxford Nanopore, etc., and the requirements thereof. In some embodiments, functional sequences can be selected for compatibility with non-commercialized sequencing systems. Examples of such sequencing systems and techniques, for which suitable functional sequences can be used, include (but are not limited to) Ion Torrent Proton or PGM sequencing, Illumina sequencing, PacBio SMRT sequencing, and Oxford Nanopore sequencing. Further, in some embodiments, functional sequences can be selected for compatibility with other sequencing systems, including non-commercialized sequencing systems.

In some embodiments, the spatial barcode 505 and functional sequences 504 are common to all of the probes attached to a given feature. In some embodiments, the UMI sequence 506 of a capture probe attached to a given feature is different from the UMI sequence of a different capture probe attached to the given feature.

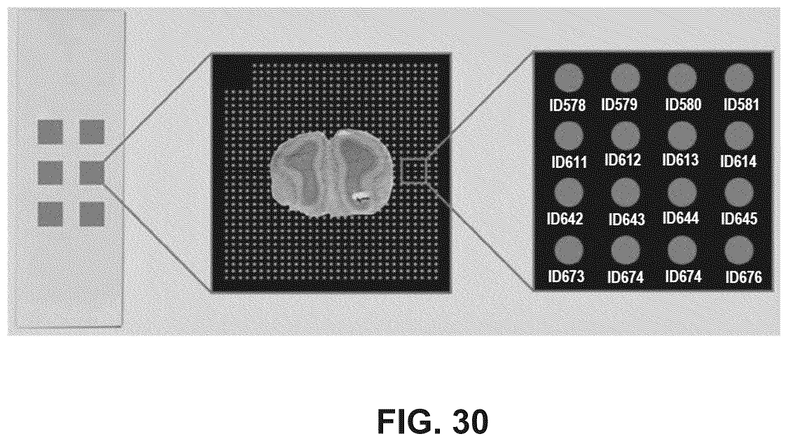

FIG. 30 depicts an exemplary arrangement of barcoded features within an array. From left to right, FIG. 30 shows (L) a slide including six spatially-barcoded arrays, (C) an enlarged schematic of one of the six spatially-barcoded arrays, showing a grid of barcoded features in relation to a biological sample, and (R) an enlarged schematic of one section of an array, showing the specific identification of multiple features within the array (labelled as ID578, ID579, ID560, etc.).

In some embodiments, more than one analyte type (e.g., nucleic acids and proteins) from a biological sample can be detected (e.g., simultaneously or sequentially) using any appropriate multiplexing technique, such as those described in Section (IV) of PCT Publication No. WO2020/176788 and/or U.S. Patent Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a biological sample (e.g., to a cell in a biological sample). In some embodiments, a plurality of molecules (e.g., a plurality of nucleic acid molecules) having a plurality of barcodes (e.g., a plurality of spatial barcodes) are introduced to a biological sample (e.g., to a plurality of cells in a biological sample) for use in spatial analysis. In some embodiments, after attaching and/or introducing a molecule having a barcode to a biological sample, the biological sample can be physically separated (e.g., dissociated) into single cells or cell groups for analysis. Some such methods of spatial analysis are described in Section (III) of PCT Publication No. WO2020/176788 and/or U.S. Patent Application Publication No. 2020/0277663.

In some cases, spatial analysis can be performed by detecting multiple oligonucleotides that hybridize to an analyte. In some instances, for example, spatial analysis can be performed using RNA-templated ligation (RTL). Methods of RTL have been described previously. See, e.g., Credle et al., Nucleic Acids Res. 2017 Aug. 21; 45(14):e128. Typically, RTL includes hybridization of two oligonucleotides to adjacent sequences on an analyte (e.g., an RNA molecule, such as an mRNA molecule). In some instances, the oligonucleotides are DNA molecules. In some instances, one of the oligonucleotides includes at least two ribonucleic acid bases at the 3′ end and/or the other oligonucleotide includes a phosphorylated nucleotide at the 5′ end. In some instances, one of the two oligonucleotides includes a capture domain (e.g., a poly(A) sequence, a non-homopolymeric sequence). After hybridization to the analyte, a ligase (e.g., a T4 RNA ligase (Rnl2), a PBCV-1 DNA Ligase or Chlorella virus DNA Ligase, a single-stranded DNA ligase, or a T4 DNA ligase) ligates the two oligonucleotides together, creating a ligation product. In some instances, the two oligonucleotides hybridize to sequences that are not adjacent to one another. For example, hybridization of the two oligonucleotides creates a gap between the hybridized oligonucleotides. In some instances, a polymerase (e.g., a DNA polymerase) can extend one of the oligonucleotides prior to ligation. After ligation, the ligation product is released from the analyte. In some instances, the ligation product is released using an endonuclease (e.g., RNase H). In some instances, the ligation product is removed using heat. In some instances, the ligation product is removed using KOH. The released ligation product can then be captured by capture probes (e.g., instead of direct capture of an analyte) on an array, optionally amplified, and sequenced, thus determining the location and optionally the abundance of the analyte in the biological sample.

In some instances, one or both of the oligonucleotides may hybridize to genomic DNA (gDNA) which can lead to false positive sequencing data from ligation events on gDNA (off target) in addition to the desired (on target) ligation events on target nucleic acids, (e.g., mRNA). Thus, in some embodiments, the disclosed methods can include contacting the biological sample with a deoxyribonuclease (DNase). The DNase can be an endonuclease or exonuclease. In some embodiments, the DNase digests single- and/or double-stranded DNA. Suitable DNases include, without limitation, a DNase I and a DNase II. Use of a DNase as described can mitigate false positive sequencing data from off target gDNA ligation events.

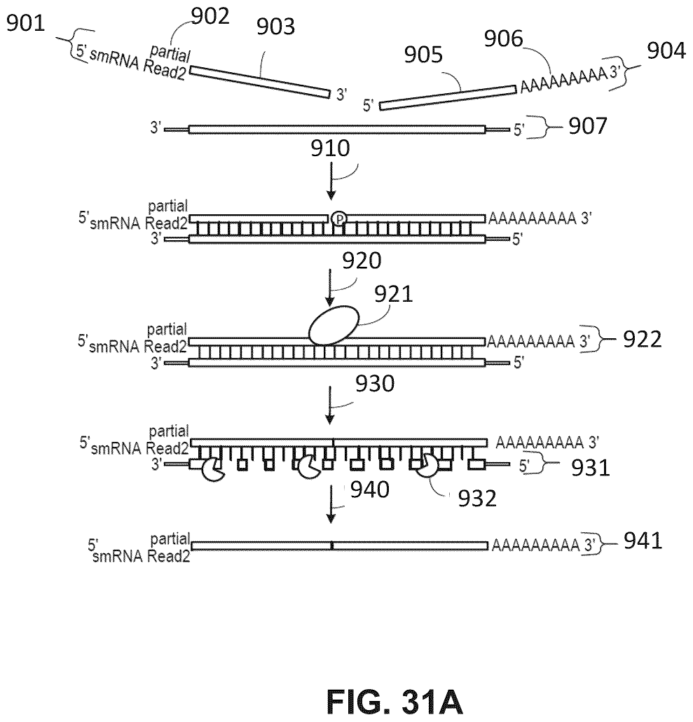

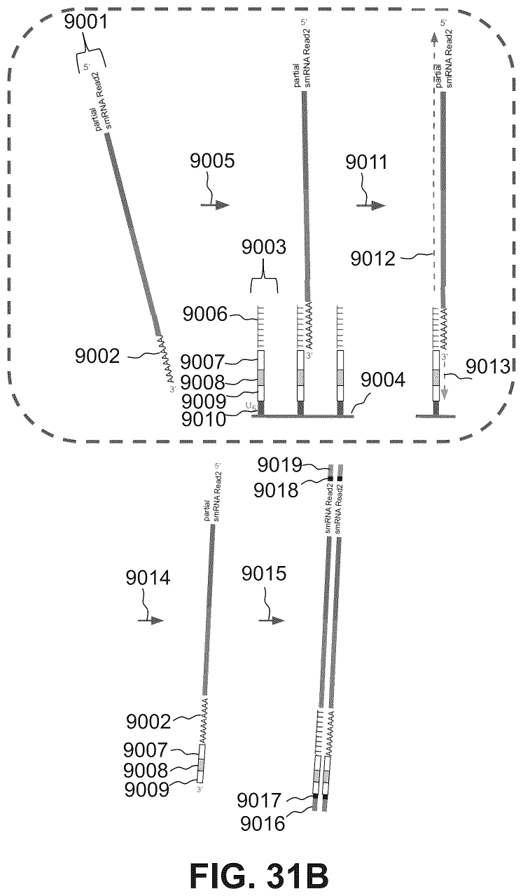

A non-limiting example of templated ligation methods disclosed herein is depicted in FIG. 31A. After a biological sample is contacted with a substrate including a plurality of capture probes and contacted with (a) a first probe 901 having a target-hybridization sequence 903 and a primer sequence 902 and (b) a second probe 904 having a target-hybridization sequence 905 and a capture domain (e.g., a poly-A sequence) 906, the first probe 901 and a second probe 904 hybridize 910 to an analyte 907. A ligase 921 ligates 920 the first probe to the second probe thereby generating a ligation product 922. The ligation product is released 930 from the analyte 931 by digesting the analyte using an endoribonuclease 932. The sample is permeabilized 940 and the ligation product 941 is able to hybridize to a capture probe on the substrate. Methods and composition for spatial detection using templated ligation have been described in PCT Publ. No. WO 2021/133849 A1, U.S. Pat. Nos. 11,332,790 and 11,505,828, each of which is incorporated by reference in its entirety.

In some embodiments, as shown in FIG. 31B, the ligation product 9001 includes a capture probe capture domain 9002, which can bind to a capture probe 9003 (e.g., a capture probe immobilized, directly or indirectly, on a substrate 9004). In some embodiments, methods provided herein include contacting 9005 a biological sample with a substrate 9004, wherein the capture probe 9003 is affixed to the substrate (e.g., immobilized to the substrate, directly or indirectly). In some embodiments, the capture probe capture domain 9002 of the ligated product specifically binds to the capture domain 9006. The capture probe can also include a unique molecular identifier (UMI) 9007, a spatial barcode 9008, a functional sequence 9009, and a cleavage domain 9010.

In some embodiments, methods provided herein include permeabilization of the biological sample such that the capture probe can more easily capture the ligation products (i.e., compared to no permeabilization). In some embodiments, reverse transcription (RT) reagents can be added to permeabilized biological samples. Incubation with the RT reagents can extend the capture probes 9011 to produce spatially-barcoded full-length cDNA 9012 and 9013 from the captured ligation products (e.g., ligation products).

In some embodiments, the extended ligation products can be denatured 9014 from the capture probe and transferred (e.g., to a clean tube) for amplification, and/or library construction. The spatially-barcoded ligation products can be amplified 9015 via PCR prior to library construction. P5 9016, i5 9017, i7 9018, and P7 9019, and can be used as sample indexes. The amplicons can then be sequenced using paired-end sequencing using TruSeq Read 1 and TruSeq Read 2 as sequencing primer sites.

In some embodiments, detection of one or more analytes (e.g., protein analytes) can be performed using one or more analyte capture agents. As used herein, an “analyte capture agent” refers to an agent that interacts with an analyte (e.g., an analyte in a biological sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (II)(b)(ix) of PCT Publication No. WO2020/176788 and/or Section (II)(b)(viii) U.S. Patent Application Publication No. 2020/0277663.

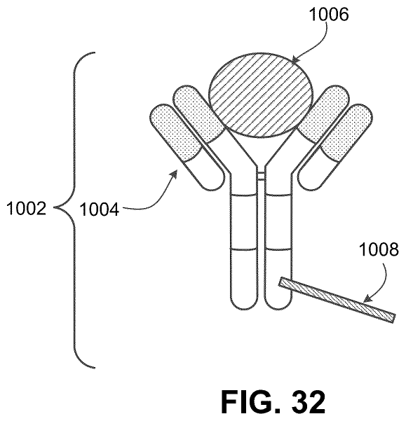

FIG. 32 is a schematic diagram of an exemplary analyte capture agent 1002 comprised of an analyte-binding moiety 1004 and an analyte-binding moiety barcode domain 1008. The exemplary analyte-binding moiety 1004 is a molecule capable of binding to an analyte 1006 and the analyte capture agent is capable of interacting with a spatially-barcoded capture probe. The analyte-binding moiety can bind to the analyte 1006 with high affinity and/or with high specificity. The analyte capture agent can include an analyte-binding moiety barcode domain 1008 which serves to identify the analyte binding moiety, and a capture domain which can hybridize to at least a portion or an entirety of a capture domain of a capture probe. The analyte-binding moiety 1004 can include a polypeptide and/or an aptamer. The analyte-binding moiety 1004 can include an antibody or antibody fragment (e.g., an antigen-binding fragment).

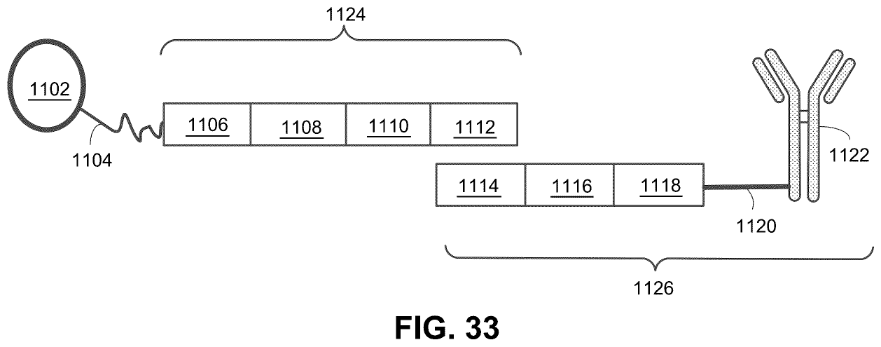

FIG. 33 is a schematic diagram depicting an exemplary interaction between a feature-immobilized capture probe 1124 and an analyte capture agent 1126. The feature-immobilized capture probe 1124 can include a spatial barcode 1108 as well as functional sequences 1106 and a UMI 1110, as described elsewhere herein. The capture probe can be affixed 1104 to a feature such as a bead 1102. The capture probe can also include a capture domain 1112 that is capable of binding to an analyte capture agent 1126. The analyte-binding moiety barcode domain of the analyte capture agent 1126 can include a functional sequence 1118, analyte binding moiety barcode 1116, and an analyte capture sequence 1114 that is capable of binding (e.g., hybridizing) to the capture domain 1112 of the capture probe 1124. The analyte capture agent can also include a linker 1120 that allows the analyte-binding moiety barcode domain (e.g., including the functional sequence 1118, analyte binding barcode 1116, and analyte capture sequence 1114) to couple to the analyte binding moiety 1122. In some embodiments, the linker is a cleavable linker. In some embodiments, the cleavable linker is a photo-cleavable linker, a UV-cleavable linker, or an enzyme cleavable linker. In some instances, the cleavable linker is a disulfide linker. A disulfide linker can be cleaved by use of a reducing agent, such as dithiothreitol (DTT), Beta-mercaptoethanol (BME), or Tris (2-carboxyethyl) phosphine (TCEP).

During analysis of spatial information, sequence information for a spatial barcode associated with an analyte is obtained, and the sequence information can be used to provide information about the spatial distribution of the analyte in the biological sample. Various methods can be used to obtain the spatial information. In some embodiments, specific capture probes and the analytes they capture are associated with specific locations in an array of features on a substrate. For example, specific spatial barcodes can be associated with specific array locations prior to array fabrication, and the sequences of the spatial barcodes can be stored (e.g., in a database) along with specific array location information, so that each spatial barcode uniquely maps to a particular array location.

Alternatively, specific spatial barcodes can be deposited at predetermined locations in an array of features during fabrication such that at each location, only one type of spatial barcode is present so that spatial barcodes are uniquely associated with a single feature of the array. Where necessary, the arrays can be decoded using any of the methods described herein so that spatial barcodes are uniquely associated with array feature locations, and this mapping can be stored as described above.

When sequence information is obtained for capture probes and/or analytes during analysis of spatial information, the locations of the capture probes and/or analytes can be determined by referring to the stored information that uniquely associates each spatial barcode with an array feature location. In this manner, specific capture probes and captured analytes are associated with specific locations in the array of features. Each array feature location represents a position relative to a coordinate reference point (e.g., an array location, a fiducial marker) for the array. Accordingly, each feature location has an “address” or location in the coordinate space of the array.

Some exemplary spatial analysis workflows are described in the Exemplary Embodiments section of PCT Publication No. WO2020/176788 and/or U.S. Patent Application Publication No. 2020/0277663. See, for example, the Exemplary embodiment starting with “In some non-limiting examples of the workflows described herein, the sample can be immersed . . . ” of PCT Publication No. WO2020/176788 and/or U.S. Patent Application Publication No. 2020/0277663. See also, e.g., the Visium Spatial Gene Expression Reagent Kits User Guide (e.g., Rev F, dated January 2022); and/or the Visium Spatial Gene Expression Reagent Kits—Tissue Optimization User Guide (e.g., Rev E, dated February 2022).

In some embodiments, spatial analysis can be performed using dedicated hardware and/or software, such as any of the systems described in Sections (II)(e)(ii) and/or (V) of PCT Publication No. WO2020/176788 and/or U.S. Patent Application Publication No. 2020/0277663, or any of one or more of the devices or methods described in Sections Control Slide for Imaging, Methods of Using Control Slides and Substrates for, Systems of Using Control Slides and Substrates for Imaging, and/or Sample and Array Alignment Devices and Methods, Informational labels of PCT Publication No. WO2020/123320.

Suitable systems for performing spatial analysis can include components such as a chamber (e.g., a flow cell or sealable, fluid-tight chamber) for containing a biological sample. The biological sample can be mounted for example, in a biological sample holder. One or more fluid chambers can be connected to the chamber and/or the sample holder via fluid conduits, and fluids can be delivered into the chamber and/or sample holder via fluidic pumps, vacuum sources, or other devices coupled to the fluid conduits that create a pressure gradient to drive fluid flow. One or more valves can also be connected to fluid conduits to regulate the flow of reagents from reservoirs to the chamber and/or sample holder.

The systems can optionally include a control unit that includes one or more electronic processors, an input interface, an output interface (such as a display), and a storage unit (e.g., a solid-state storage medium such as, but not limited to, a magnetic, optical, or other solid state, persistent, writeable and/or re-writeable storage medium). The control unit can optionally be connected to one or more remote devices via a network. The control unit (and components thereof) can generally perform any of the steps and functions described herein. Where the system is connected to a remote device, the remote device (or devices) can perform any of the steps or features described herein. The systems can optionally include one or more detectors (e.g., CCD, CMOS) used to capture images. The systems can also optionally include one or more light sources (e.g., LED-based, diode-based, lasers) for illuminating a sample, a substrate with features, analytes from a biological sample captured on a substrate, and various control and calibration media.

The systems can optionally include software instructions encoded and/or implemented in one or more of tangible storage media and hardware components such as application specific integrated circuits. The software instructions, when executed by a control unit (and in particular, an electronic processor) or an integrated circuit, can cause the control unit, integrated circuit, or other component executing the software instructions to perform any of the method steps or functions described herein.

In some cases, the systems described herein can detect (e.g., register an image) the biological sample on the array. Exemplary methods to detect the biological sample on an array are described in PCT Publication No. WO2021/102003 and/or U.S. Patent Application Publication No. 2021/0150707, each of which is incorporated herein by reference in their entireties.

Prior to transferring analytes from the biological sample to the array of features on the substrate, the biological sample can be aligned with the array. Alignment of a biological sample and an array of features including capture probes can facilitate spatial analysis, which can be used to detect differences in analyte presence and/or level within different positions in the biological sample, for example, to generate a three-dimensional map of the analyte presence and/or level. Exemplary methods to generate a two- and/or three-dimensional map of the analyte presence and/or level are described in PCT Publication No. WO2020/053655 and spatial analysis methods are generally described in PCT Publication No. WO2021/102039 and/or U.S. Patent Application Publication No. 2021/0155982, each of which is incorporated herein by reference in their entireties.

In some cases, a map of analyte presence and/or level can be aligned to an image of a biological sample using one or more fiducial markers, e.g., objects placed in the field of view of an imaging system which appear in the image produced, as described in the Substrate Attributes Section, Control Slide for Imaging Section of PCT Publication Nos. WO2020/123320, WO 2021/102005, and/or U.S. Patent Application Publication No. 2021/0158522, each of which is incorporated herein by reference in their entireties. Fiducial markers can be used as a point of reference or measurement scale for alignment (e.g., to align a sample and an array, to align two substrates, to determine a location of a sample or array on a substrate relative to a fiducial marker) and/or for quantitative measurements of sizes and/or distances.

The subject matter described herein may be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

One or more aspects or features of the subject matter described herein may be realized in digital electronic circuitry, integrated circuitry, specially designed ASICs, field programmable gate arrays (FPGAs) computer hardware, firmware, software, and/or combinations thereof. These various aspects or features may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which may also be referred to as programs, software, software applications, applications, components, or code, include machine instructions for a programmable processor, and may be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example, as would a processor cache or other random-access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

What is claimed is:

1. A system comprising:
an upper housing comprising
a linear actuator,
a linear motion member coupled to the linear actuator,
a tilt member rotatably coupled to the linear motion member, and
at least one sample support member coupled to the tilt member;
a lower housing comprising a base support member; and
an alignment mechanism coupling the upper housing to the lower housing, wherein
the upper housing and the lower housing have an open configuration and a closed configuration, the alignment mechanism is configured to move the upper housing and the lower housing between the open configuration and the closed configuration;
in the closed configuration, the linear actuator is configured to, upon energizing, translate the at least one sample support member towards the base support member.

2. The system of claim 1, wherein the alignment mechanism comprises a hinge.

3. The system of claim 1, wherein the alignment mechanism comprises a multi-arm linkage.

4. The system of claim 1, wherein the upper housing further comprises a frame having at least one bushing, wherein the linear motion member comprises at least one shaft disposed within the at least one bushing.

5. The system of claim 1, further comprising at least one tension spring coupling the linear motion member to the tilt member.

6. The system of claim 1, further comprising at least one compression spring coupling the tilt member to the at least one sample support member.

7. The system of claim 1, wherein the tilt member is coupled to the linear motion member via at least two pivots.

8. The system of claim 7, wherein the at least two pivots comprise a ball-in-slot pivot.

9. The system of claim 7, wherein the at least two pivots comprise a ball-in-place pivot.

10. The system of claim 1, wherein the linear motion member comprises a first arm and a second arm together defining a rotational axis, the tilt member is rotatably coupled to the first arm and the second arm, and the tilt member is configured to rotate about the rotational axis.

11. The system of claim 1, wherein each of the at least one sample support member is coupled to the tilt member via a ball-in-slot joint and a ball joint.

12. The system of claim 1, wherein the upper housing further comprises at least one stopper configured to limit an angular range of motion of the at least one sample support member.

13. The system of claim 1, wherein the linear motion member comprises an upper linear motion member and a lower linear motion member, wherein the upper linear motion member is coupled to the lower linear motion member and the upper linear motion member is coupled to the linear actuator.

14. The system of claim 13, wherein the lower linear motion member comprises a first aperture, the tilt member comprises a second aperture, and each of the at least one sample support members comprises a sample window.

15. The system of claim 14, wherein the upper housing further comprises a light emitting diode (LED) assembly positioned on the lower linear motion member, wherein the LED assembly is configured to emit light through the first aperture, second aperture, and the sample window for each of the at least one sample support member.

16. The system of claim 15, wherein the LED assembly comprises a light guide, wherein the light guide comprises a top surface, a bottom surface, and at least one side, a plurality of LEDs positioned around the light guide and configured to direct light through the at least one side, and a light diffuser positioned below the bottom surface of the light guide.

17. The system of claim 16, wherein an area of the light guide substantially equals the area of the first aperture.

18. The system of claim 17, wherein the top surface of the light guide comprises a reflective layer.

19. The system of claim 18, wherein the reflective layer comprises a metal.

20. The system of claim 18, wherein the reflective layer comprises a silvered surface.

21. The system of claim 18, wherein the reflective layer comprises a coating.

22. The system of claim 21, wherein the coating comprises nanoparticles disposed within a matrix.

23. The system of claim 22, wherein the nanoparticles comprise metallic oxide nanoparticles.

24. The system of claim 23, wherein the nanoparticles comprise aluminum oxide nanoparticles or titanium dioxide nanoparticles.

25. The system of claim 22, wherein a mean diameter of the nanoparticles is less than or equal to 600 nm.

26. The system of claim 22, wherein the matrix comprises an epoxy polymer.

27. The system of claim 15, wherein the lower housing further comprises a focus stage, wherein the focus stage comprises a stage, a motor configured to translate the stage, and at least one image sensor positioned on the stage, and at least one lens positioned on the stage.

28. The system of claim 27, wherein the base support member comprises at least one base window, wherein each of the at least one base window is configured to align with the at least one sample window in the closed configuration.

29. The system of claim 28, wherein the lower housing further comprises at least one mirror configured to reflect light from the LED assembly to the at least one image sensor.

30. The system of claim 29, wherein the at least one mirror comprises a right-angle prism.

31. The system of claim 1, wherein the base support member defines a first plane at a first angle relative to a horizontal plane.

32. The system of claim 31, wherein the first angle is about 3 degrees.

33. The system of claim 31, wherein the at least one sample support member defines a second plane at a second angle relative to the first plane.

34. The system of claim 33, wherein the second angle is about 4 degrees.

35. The system of claim 1, further comprising a spacer configured to maintain a predetermined distance between the at least one sample support member and the base support member after the linear actuator translates the at least one sample support member toward the base support member.

36. The system of claim 1, further comprising at least one first retaining mechanism positioned on the at least one sample support member and configured to retain a sample substrate against the sample support member.

37. The system of claim 36, wherein the at least one first retaining mechanism comprises a clip.

38. The system of claim 36, further comprising at least one second retaining mechanism positioned on base support member and configured to retain an array substrate within the base support member, wherein the at least one second retaining mechanism includes a spring-loaded member.
